(19) United States
(12) Patent Application Publication
(10) Pub. No.: US 2023/0297898 A1
(43) Pub. Date: Sep. 21, 2023

(54) SYSTEM FOR DIGITALLY INTERACTING WITH LIVE MUSICIANS TO FACILITATE TIPPING, REQUESTS, AND REQUEST BOOSTING

(71) Applicant: Live Music Network, LLC, Starkville, MS (US)

(72) Inventors: Samuel James Miller, Smyrna, TN (US); Logan Rex Martin, Smyrna, TN (US)

(73) Assignee: Live Music Network, LLC, Starkville, MS (US)

(21) Appl. No.: 18/200,448

(22) Filed: May 22, 2023

Related U.S. Application Data
(63) Continuation of application No. 16/674,981, filed on Nov. 5, 2019, now abandoned.
(60) Provisional application No. 62/828,951, filed on Apr. 3, 2019.

(51) Int. Cl. G06Q 10/02; G06Q 50/10; G06Q 20/10; G06Q 20/32

(52) U.S. Cl. CPC G06Q 10/02; G06Q 50/10; G06Q 20/102; G06Q 20/322

(57) ABSTRACT

The present disclosure is a system for digitally interacting with an artist or band that is playing a live show. The system has a first mobile device operated by a listener and comprising a processor, the processor configured receives data from the listener indicative of at least one live performance and data indicative of a requested song the listener desires to see performed at the performance, the mobile device further receives data indicative of an amount of money the listener desires to pay to hear the requested song. The system further has a second mobile device operated by an Artist or Band and comprising a processor, the processor receives data indicative of the requested song, and the Artist or Band performs the requested song. Further, the system comprises at least one server, the server comprising a processor that receives data indicative of the requested song, the server further comprising a plurality of data indicative of other songs requested by other listeners for which amount of money were paid to hear the songs performed, the processor, based on the amount of money received from the listener and the other amounts of money received by other listeners, determine which requested song is played in what order.

### CROSS-REFERENCE TO RELATED APPLICATION

This application claims is a continuation of and claims priority to U.S. Nonprovisional application Ser. No. 16/674,981 entitled System for Digitally Interacting with Live Musicians to Facilitate Tipping, Requests, and Request Boosting and filed Nov. 5, 2019 claiming priority to U.S. Provisional Patent Application Ser. No. 62/828,951 entitled Novel Mobile Software System to Digitally Interact with Live Musicians to Facilitate Tipping, Song Requests, and a Live Bidding Auction Methodology filed on Apr. 3, 2019, each of which is incorporated herein by reference.

### BACKGROUND

Many people frequent bars or other entertainment venues to watch bands perform live music. Often, the individuals in the audience participate in selecting what music is played by the artists. In this regard, an individual in the audience can walk to the stage, ask the artist to play a song, and provide a sum of money to the artists to play the song requested as a tip. A second individual may approach the stage on which the band is performing and offer another sum of money to the artists to play a different song. This second individual may pay a premium to the artist to get their song request played before other songs that have been requested.

Also, some bands who perform live at these bars or other entertainment venues perform only for the tips they receive from the audience. Thus, frequently, a container, e.g., a hat or a bucket, is passed around the audience in the bar or other entertainment venues. If individuals in the audience want to tip the artists in the band performing the individuals in the audience place money in the container.

### BRIEF DESCRIPTION OF THE DRAWINGS

FIG. 1A is a block diagram of a system for digitally interacting with live musicians to facilitate tipping, song requests, and live bidding in accordance with an embodiment of the present disclosure.

FIG. 1B is a block diagram of an exemplary internal server shown in FIG. 1.

FIG. 1C is a block diagram of an exemplary payment server shown in FIG. 1.

FIG. 2 is a block diagram of an exemplary mobile device shown in FIG. 1.

FIG. 3 is an exemplary Welcome Graphical User Interface (GUI) implemented in the system of FIG. 1A.

FIG. 4 is an exemplary Sign Up GUI implemented in the system of FIG. 1A.

FIG. 5 is an exemplary Confirm You Email GUI implemented in the system of FIG. 1A.

FIG. 6 is an exemplary Profile Set Up GUI implemented in the system of FIG. 1A.

FIG. 7 is an exemplary Genre GUI implemented in the system of FIG. 1A.

FIG. 8 is an exemplary Share Your Location GUI implemented in the system of FIG. 1A.

FIG. 9 is an exemplary Request a Song and a Setlist GUI implemented in the system of FIG. 1A.

FIG. 10 is an exemplary Request a Song GUI implemented in the system of FIG. 1A.

FIG. 11 is an exemplary Setlist GUI implemented in the system of FIG. 1A.

FIG. 12 is an exemplary Add Payment Method GUI implemented in the system of FIG. 1A.

FIG. 13 is an exemplary Payment Type GUI implemented in the system of FIG. 1A.

FIG. 14 is an exemplary Add Payment Method GUI implemented in the system of FIG. 1A.

FIG. 15 is an exemplary Thanks for Request a Song GUI implemented in the system of FIG. 1A.

FIG. 16 is an exemplary Boost Your Song GUI implemented in the system of FIG. 1A.

FIG. 17 is an exemplary Songs GUI implemented in the system of FIG. 1A.

FIG. 18 is an exemplary Events GUI implemented in the system of FIG. 1A.

FIG. 19 is an exemplary Members GUI implemented in the system of FIG. 1A.

FIG. 20 is an exemplary About GUI implemented in the system of FIG. 1A.

FIG. 21 is an exemplary Add Payment Method GUI implemented in the system of FIG. 1A.

FIG. 22 is an exemplary Profile GUI implemented in the system of FIG. 1A.

FIG. 23 is an exemplary Band Edit Profile GUI implemented in the system of FIG. 1A.

FIG. 24 is an exemplary My Activity Tipping GUI implemented in the system of FIG. 1A.

FIG. 25 is an exemplary My Activity Requests GUI implemented in the system of FIG. 1A.

FIG. 26 is an exemplary My Activity Likes GUI implemented in the system of FIG. 1A.

FIG. 27 is an exemplary Search GUI implemented in the system of FIG. 1A.

FIG. 28 is an exemplary Search Location GUI implemented in the system of FIG. 1A.

FIG. 29 is an exemplary Calendar GUI implemented in the system of FIG. 1A.

FIG. 30 is an exemplary Map GUI showing no events found implemented in the system of FIG. 1A.

FIG. 31 is an exemplary Connect GUI implemented in the system of FIG. 1A.

FIG. 32 is an exemplary Map GUI showing events found on the map implemented in the system of FIG. 1A.

FIG. 33 is an exemplary Map GUI showing Artists or Bands to which a listener is connected implemented in the system of FIG. 1A.

FIG. 34 is an exemplary Search GUI for searching for Artists, Events or Users implemented in the system of FIG. 1A.

FIG. 35 is an exemplary Newsfeed GUI showing no entries in the Newsfeed implemented in the system of FIG. 1A.

FIG. 36 is an exemplary Newsfeed GUI showing entries implemented in the system of FIG. 1A.

FIG. 37 is an exemplary Discover GUI for viewing Popular Artists, Artists or Bands with Genres, and New Artists implemented in the system of FIG. 1A.

FIG. 38 is an exemplary Popular Country Artists GUI implemented in the system of FIG. 1A.

FIG. 39 is an exemplary Discover New Artists GUI implemented in the system of FIG. 1A.

FIG. 40 is an exemplary Discover Popular Artists GUI implemented in the system of FIG. 1A.

FIG. 41 is an exemplary Notifications GUI implemented in the system of FIG. 1A.

FIG. 42 is an exemplary Artist or Band Profile GUI implemented in the system of FIG. 1A.

FIG. 43 is an exemplary All Events GUI implemented in the system of FIG. 1A.

FIG. 44 is an exemplary Interested Events GUI implemented in the system of FIG. 1A.

FIG. 45 is an exemplary Tell Us More GUI implemented in the system of FIG. 1A.

FIG. 46 is an exemplary Select Genres GUI implemented in the system of FIG. 1A.

FIG. 47 is an exemplary Dashboard GUI implemented in the system of FIG. 1A.

FIG. 48 is an exemplary Add New Event GUI implemented in the system of FIG. 1A.

FIG. 49 is an exemplary My Songs Library GUI implemented in the system of FIG. 1A.

FIG. 50 is an exemplary Add New Event Calendar GUI implemented in the system of FIG. 1A.

FIG. 51 is an exemplary Coming GUI implemented in the system of FIG. 1A.

FIG. 52 is an exemplary Notifications GUI showing notification entries implemented in the system of FIG. 1A.

FIG. 53 is an exemplary Add New Event Search GUI implemented in the system of FIG. 1A.

FIG. 54 is an exemplary Share Your Event GUI implemented in the system of FIG. 1A.

FIG. 55 is an exemplary Search Invitees GUI implemented in the system of FIG. 1A.

FIG. 56 is an exemplary Edit Profile GUI for Artists and Bands implemented in the system of FIG. 1A.

FIG. 57 is an exemplary Events GUI for Artists and Bands implemented in the system of FIG. 1A.

FIG. 58 is an exemplary Songs GUI for Artists and Bands implemented in the system of FIG. 1A.

FIG. 59 is an exemplary About GUI for Artists and Bands implemented in the system of FIG. 1A.

FIG. 60 is an exemplary Members GUI for Artists and Bands implemented in the system of FIG. 1A.

FIG. 61 is an exemplary Events GUI for Artists and Bands showing tips made per song implemented in the system of FIG. 1A.

FIG. 62 is an exemplary Events GUI for Artists and Bands showing tips made per song, songs performed, and songs not yet performed implemented in the system of FIG. 1A.

FIG. 63 is an exemplary Events GUI for Artists and Bands showing tips made per song, songs performed, and songs not yet performed and including a marker showing that a song is completed and the amount of time it took to complete the song implemented in the system of FIG. 1A.

FIG. 64 is an exemplary Events GUI for Artists and Bands showing tips made per song implemented in the system of FIG. 1A.

FIG. 65 is an exemplary Events Summary GUI for Artists and Bands implemented in the system of FIG. 1A.

FIG. 66 is an exemplary Artist or Band Profile GUI for Artists and Bands implemented in the system of FIG. 1A.

FIG. 67 is an exemplary Statistics GUI for Artists and Bands implemented in the system of FIG. 1A.

### DETAILED DESCRIPTION

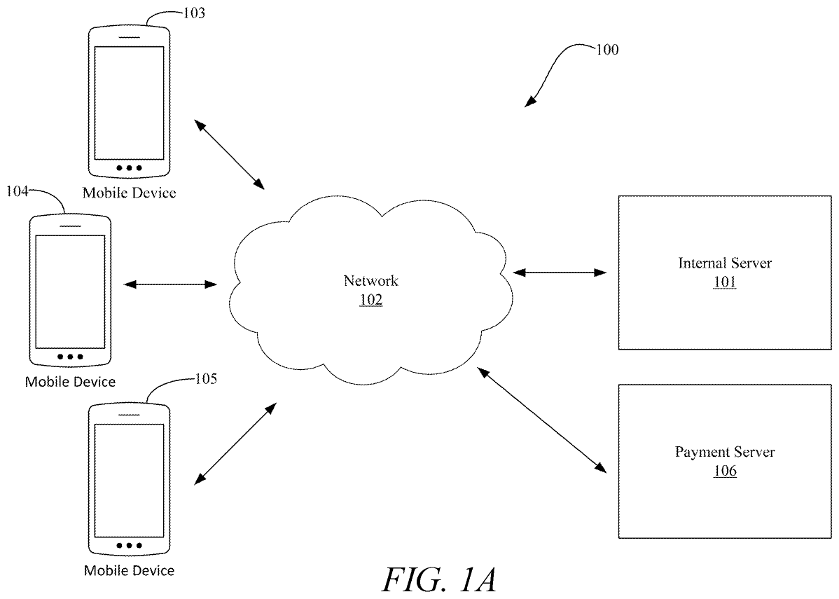

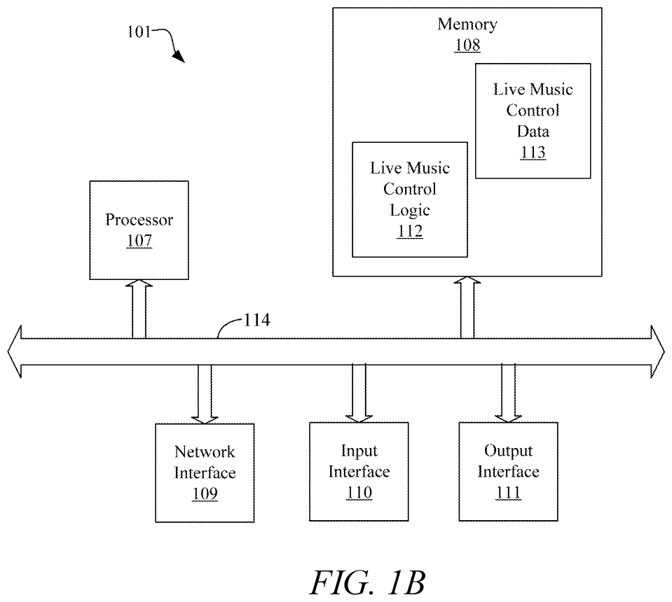

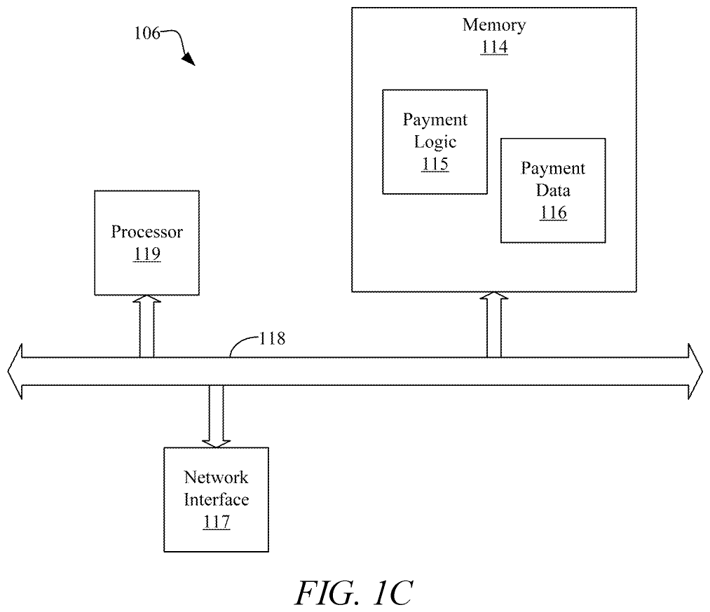

FIG. 1A is a block diagram of an exemplary system 100 for digitally interacting with live musicians to facilitate tipping, song requests, and live bidding in accordance with an embodiment of the present disclosure. The system 100 comprises a plurality of mobile devices 103-105, an internal server 101 and a payment server 106. The mobile devices 103-105 and the servers 101 and 106 communicate via a network 102.

In one embodiment, network 102 is a mobile network or a cellular network. The mobile or cellular networks are communication networks where the last link is wireless. The communication network is comprised of a group of devices that communicate. The network 102 is configured to be distributed over land areas often called cells, and each cell has its own transceiver. The cell is often referred to as a base station. A base station provides the cell with the network coverage, which can be used for transmission of voice, data, and other types of content.

The mobile devices 103-105 may be any type of hand-held device that can be used to communicate with servers 101 and 106 via the network 102. In one embodiment, the mobile devices 103-105 are mobile phones that communicate over the network 102 with the servers 101 and 106. In another embodiment, the mobile devices 103-105 are tablets that communicate with servers 101 and 106 over the network 102. Stored on each mobile device 103-105 that is coupled to the server 101 is a live music network application (not shown) (hereinafter referred to as “the app”).

Internal server 101 is a computing device that communicates via the network 102. In this regard, server 101 communicates with the mobile devices 103-105 and the payment server 106. The internal server 101 controls functions related to the app. For example, the mobile device 103 decides to create an event, e.g., a live music show. The app sends data indicative of creating an event to internal server 101. The server 101 then displays to others on the network, e.g., mobile devices 104-105, that the event has been created, and they may join the created event.

Payment server 106 is a computing device that is configured to communicate via the network 102. In this regard, the server 106 is configured to communicate with the mobile devices 103-105 and the Internal server 101. During the event, when users want to request a song for payment or tip a live band money, data indicative of the request is sent to the payment server 106. The payment server 106 has registration information, and the payment server 106 debits the user's account the payment amount, then transmits data indicative of the transaction, song for payment or tipping the band to the internal server 101. The internal server 101 can broadcast the information about the transaction to mobile devices 103-105. Notably, the internal server 101 may display a tip to the mobile devices' displays who have previously joined the event, or the internal server 101 may display a song request accompanied by the amount provided to the mobile device's displays.

In operation, a user (not shown) of the mobile device 103 may request software, the app, to be downloaded to their mobile device 103. The mobile device 103 transmits data requesting the download to the internal server 101, and the internal server 101 transfers data indicative of the app to the mobile phone 103. Likewise, a user (not shown) of the mobile device 104 may request the app to be downloaded to their mobile device 104. Therefore, the mobile device 104 transmits data requesting the download to the internal server 101, and the internal server 101 transfers data indicative of the app to the mobile phone 104.

To use the app downloaded to the mobile devices 103 and 104, the user registers their app. To register their app, the user enters data indicative of payment information into the app that is transmitted to and stored on the payment server 106. Data may include, for example, the user's name, the user's billing address, a debit card number, a credit card number, or a routing number, the effective date of the instrument and a security code on the instrument. Data indicative of the user's name, the user's billing address are stored on the internal server 101.

Once a user has registered with the payment server 106, the user may create or join an event. Note that an event is a live band event in which the artists are playing live on a stage, for example. As an example, the user may create an event using mobile device 103 that is the live showing of Band A. Data describing the event is transmitted to the internal server 101 and saved on server 101. Thereafter, users of mobile device 104 and mobile device 105 desire to attend the event and participate using the downloaded app, which is displayed on the mobile device 104 and mobile device 105. These users of mobile device 104 and mobile device 105 can join the event by selecting on their respective displays. If selected, the app transmits data to the internal server 101 data indicating that the users desire to join the event. The internal server 101 then associates data indicative of the user and the mobile device 104 and mobile device 105 with the event. Further, the internal server 101 updates the displays of mobile devices 103-105 to show the attendees of who have joined the event.

During the live performance of Band A, the user of mobile device 103 may decide that they want to hear a particular song that is on a prepopulated song list for Band A displayed by the app to the display device of mobile device 103. The user selects a song through the app from the song list for Band A and provides a dollar amount they will pay to hear the song.

When song selection occurs, data indicative of the payment incident is sent to the payment server 106. The server 106 performs the monetary transaction, e.g., debiting a credit card the dollar amount the user indicated they would pay. Once the monetary transaction is complete, the server 106 transmits data indicative of the song selection event to the internal server 101. In the example discussed, the internal server will broadcast to joined users the song selected, and the dollar amount associated with the function of selecting a song to be played.

As noted hereinabove, the app also has tipping functionality. During the live performance of Band A, the user of mobile device 103 decides that they want to tip Band A. The user performs a function by selecting the tipping functionality of the app and entering a tip amount.

When this function occurs, data indicative of the tipping event is sent to the payment server 106. The server 106 performs the monetary transaction, e.g., debiting a credit card, the dollar amount the user indicated they would tip. Once the monetary transaction is complete, the server 106 transmits data indicative of the function to the internal server 101. In the example discussed, the internal server will broadcast that Band A got tipped and display the tip amount.

Note that one of the mobile devices 103-105 may be Band A's mobile device. Thus, Band A can see song requests, so they can play the songs requested. Band A can also see the monetary value of the tips they have been receiving during the performance.

FIG. 1B depicts an exemplary embodiment of the internal server 101 depicted in FIG. 1A. As shown by FIG. 1B, the internal server 101 comprises a processor 107 and memory 108. Stored in memory 108 is live music control logic 112 and live music control data 113. Further the internal server 101 comprises a network interface 109 that allows the internal server 101 to communicate over network 102.

The exemplary embodiment of the internal server 101 depicted by FIG. 1B comprises at least one conventional processing element 107, such as a digital signal processor (DSP) or a central processing unit (CPU), that communicates to and drives the other elements within the internal server 101 via a local interface 112, which can include at least one bus. Further, the processing element 107 executes instructions of software, such as the live music control logic 112.

The live music control logic 112 controls the functionality of the internal server 101, as will be described in more detail hereafter. It should be noted that the live music control logic 112 can be implemented in software, hardware, firmware, or any combination thereof. In an exemplary embodiment illustrated in FIG. 1B, the live music control logic 112 is implemented in software and stored in memory 108.

Note that the live music control logic 112, when implemented in software, can be stored, and transported on any computer-readable medium for use by or in connection with an instruction execution apparatus that can fetch and execute instructions. In the context of this document, a “computer-readable medium” can be any means that can contain or store a computer program for use by or in connection with an instruction execution apparatus.

The network interface 109 is any type of device that allows internal server 101 to communicate with payment server 106 and/or mobile devices 103-105. For example, the network interface may interface with a hub, switch, router, bridge, gateway, modem, repeater, or access point.

An input interface 110, for example, a keyboard, keypad, or mouse, can be used to input data from a user of the internal server 101, and an output interface 111, for example, a printer or display screen (e.g., a liquid crystal display (LCD)), can be used to output data to the user.

In operation, the processor executes the instructions contained in the live music control logic 112. In one embodiment, the live music control logic 112 receives a request to add a user. In such a request, the live music control logic 112 stores in live music control data 113 information identifying the user. For example, live music control logic 112 may store a person's name, address, phone number email, etc.

As described above, a user may select a song from a predetermined list of songs displayed on the mobile phone 103-105 (FIG. 1A) and provided by the internal server 101. Each song selected has associated with it a fee. In such a scenario, payment server 106 would perform the financial transaction to collect the money for the live music control logic 112 broadcasts data indicating when the song will be played based on its ranking to user's who previously joined the event related to the song request. Note that the song's ranking is determined by how much money the user paid for the selected song. For example, another user may select a different song and pay more money in which case the song for which the user paid more money will be played before the user who paid less money. During the event, the Artist or Band accumulates an amount of money from listeners via song requests payments and tipping payments. During the event or after the event has ended, the payment server 106 credits the bank account or other financial account, e.g., a debit or credit card, of the Artist or Band that received the song request payments and the tipping payments.

Further, the internal server 101 and the payment server 106 perform the tipping function of the system 101. In this regard, the payment server 106 will receive a request to tip a live band that is performing. The payment server 106 performs the financial transaction, e.g., debits a credit card. Once the financial transaction has completed, the payment server 106 transmits the request to tip to the internal server 101.

Once received by the internal server 101, the internal server 101 stores data indicative of the tip. In this regard, the user's name and other identifying information are already stored in the live music control data 113. Thus, the live music control logic 112 associates the user's name with the tip amount in the live music control data 113. Further, the live music control logic 112 broadcasts data identifying the tip amount to the mobile devices 103-105 that have previously joined the event for which the tip request was made.

FIG. 1C depicts an exemplary embodiment of the payment server 106 depicted in FIG. 1A. As shown by FIG. 1C, payment server 106 comprises a processor 119 and memory 114. Stored in memory 114 is payment logic 115 and payment data 116 Further the payment server 106 comprises a network interface 117 that allows the payment server 106 to communicate over network 102.

The exemplary embodiment of the payment server 106 depicted by FIG. 1C comprises at least one conventional processing element 119, such as a digital signal processor (DSP) or a central processing unit (CPU), that communicates to and drives the other elements within the payment server 106 via a local interface 118, which can include at least one bus. Further, the processing element 119 executes instructions of software, such as the payment logic 115.

The payment logic 115 controls the functionality of the payment server 106, as described herein. It should be noted that the payment logic 115 can be implemented in software, hardware, firmware, or any combination thereof. In an exemplary embodiment illustrated in FIG. 1C, the payment logic 115 is implemented in software and stored in memory 114.

Note that the payment logic 115, when implemented in software, can be stored, and transported on any computer-readable medium for use by or in connection with an instruction execution apparatus that can fetch and execute instructions. In the context of this document, a “computer-readable medium” can be any means that can contain or store a computer program for use by or in connection with an instruction execution apparatus.

The network interface 109 is any type of device that allows payment server 106 to communicate with payment server 106 and/or mobile devices 103-105. For example, the network interface may interface with a hub, switch, router, bridge, gateway, modem, repeater, or access point.

The function of the payment server 106 is to perform monetary transactions based upon data received from mobile devices 103-105. To effectuate this, when a new user downloads the app from the internal server 101, the user registers with their payment information, e.g., credit card number, debit card number, bank routing number and account number, which is stored in payment data 116.

Thereafter, a mobile phone 103 transmits data indicative of a song request to the payment server 106. Based upon the information in the request, the payment logic 115 retrieves the user's information in the payment data 116 and performs the financial transaction based on the payment data 116 retrieved.

When the financial transaction is completed, the payment logic 115 transmits data indicative of the song request to the internal server 101. The internal server 101 broadcasts the tip amount to mobile devices 103-105 of those listeners who have previously joined the event for which the tip was given.

The mobile phone 103 may transmit data indicative of a tip request to the payment server 106. Based upon the information in the request, the payment logic 115 retrieves the user's information in the payment data 116 and performs the financial transaction based on the payment data 116 retrieved.

When the financial transaction is completed, the payment logic 115 transmits data indicative of the tip request to the internal server 101. The internal server 101 broadcasts the user's name and tip amount to those who have previously joined the event related to the song request.

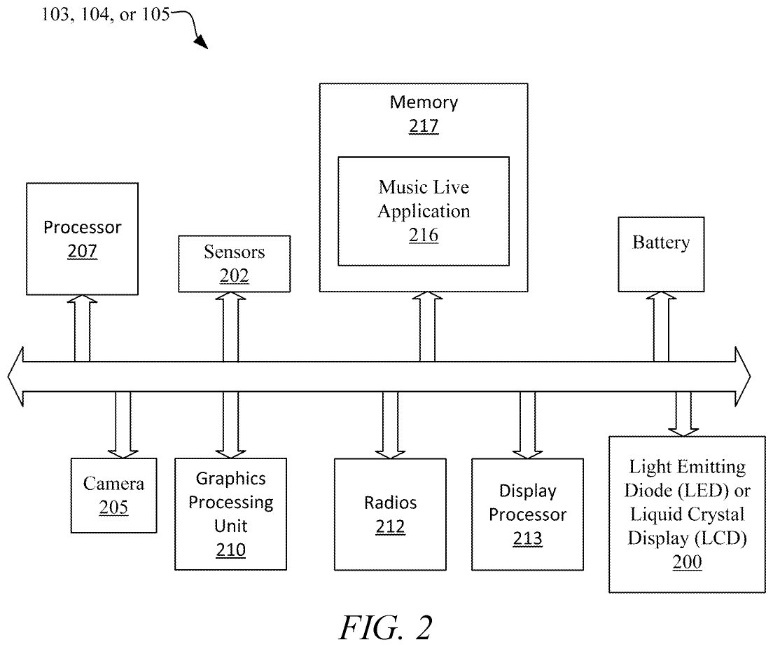

FIG. 2 is a block diagram of a mobile device 103-105 as depicted in FIG. 1A. The mobile device's architecture is complicated and comprises varying components. FIG. 2 depicts mobile phone 103-105 that comprises a processor 207. While shown as a single chip, the processor 207 is typically a component on the mobile phone's system on a chip (SOC). This SOC can comprise multiple chips that serve different purposes. For example, the SOC may include memory, input/output ports, and secondary storage.

Further, the mobile device 103-105 comprises a variety of sensors. The sensors can include proximity sensors that are used to detect the presence of nearby objects. The mobile phone 103-105 may include an accelerometer used to detect the orientation of the phone. Also, the mobile phone 103-105 may include a gyroscope, which adds an additional dimension to the information supplied by the accelerometer by tracking rotation or twist. Further, the mobile phone 103-105 may come equipped with a magnetometer, otherwise known as a compass. With its ability to sense magnetic fields, this device detects compass heading relative to the Earth's magnetic north pole.

The mobile phone 103-105 further comprises a camera 205 that allows the mobile devices 103-105 to take photographs. It also comprises a battery to provide power to the cell device. The mobile devices 103-105 also comprise a graphics processing unit (GPU) 210, which is a specialized electronic circuit designed to rapidly manipulate and alter memory to accelerate the creation of images in a frame buffer intended for output to a display device.

Radios 212 are on the mobile phones 103-105 to allow the mobile phones 103-105 to communicate wirelessly. The display processor 213 controls the data displayed to the light-emitting diode (LED) or the liquid crystal display (LCD) 200.

In addition, the mobile phone 103-105 comprises memory 217. In one embodiment, the memory is random access memory (RAM). Stored in RAM is the music live application 216. The music live application 216 is the user interface between the servers 101 and 106 and the users of the mobile devices 103-105. Note that the music live application 216 may be hardware, software, firmware, or a type of program executable by the processor 207.

In operation, the music live application 216 displays screens for registration with the servers 101 and 106. It further receives input from the users. For example, if a user requests a song, the music live application 216 transmits data indicative of the song and a monetary amount to the payment server 106. After the financial transaction is completed, the song request and money amount are transmitted to the internal server 101, which broadcasts the song and the dollar amount to all mobile devices 103-105 via the music live application 216 that previously joined the event related to the song request.

Similarly, the music live application 216 displays screens for inputting information related to a tip. The music live application 216 transmits data indicative of the user who is tipping and a tip amount to the payment server 106. After the financial transaction is completed, the tip request and money amount are transmitted to the internal server 101, which broadcasts the user and the tip amount to all mobile phones via the music live application 216 that previously joined the event related to the song request.

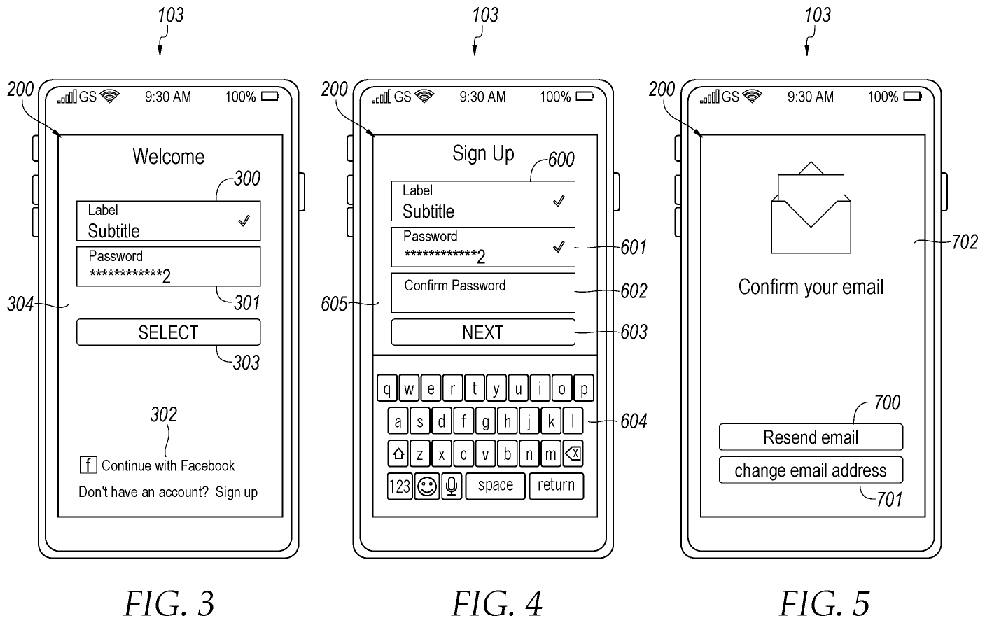

Each of the FIGS. 3-78 depicts the mobile device 103, each displaying a different graphical user interface (GUI) in accordance with the architecture and functionality of an embodiment of the system 100. Note that the description discusses mobile device 103, but the same FIGS. 3-78 also applies to mobile devices 104 and 105.

FIG. 3 depicts an exemplary Welcome GUI 304 displayed to the display device 200 of the mobile device 103 by the music live application 216 (FIG. 2). The Welcome GUI 304 allows a listener who is already registered to sign into the system 100. The Welcome GUI 304 has a Label textbox 300 in which a user enters their label, also known as a username. Further, the Welcome GUI 304 has a Password textbox 301 in which a user enters their password. After the label and password are entered, the user selects the Select pushbutton 303, and the music live application 216 allows the user access to the system 100. Note that if the user desires, they can log on to the system 100 by selecting the Continue With Facebook hyperlink 302 and log on with their Facebook user identification and password.

FIG. 4 depicts an exemplary SignUp GUI 605 displayed to the display device 200 of the mobile device 103 by the music live application 216. The SignUp GUI 605 allows a new user to provide credentials with which the user may use to access the system 100. The new user enters their label in a Label textbox 600 using keypad 604. The user enters a password in the Password text box 601 and enters the password again in the Confirm Password text box 602 using keypad 604. Once the information is entered, the user selects the NEXT pushbutton 603, and the music live application 216 (FIG. 2) displays the Confirm Your Email GUI 702 depicted in FIG. 5.

When the user navigates to the Confirm Your Email GUI 702 depicted in FIG. 5, the music live application 216 (FIG. 2) transmits an email to the user. To verify, the user selects a “Verify” button in the email. Then the user has access to the system 100. Through this transmitted email the user may respond by sending an email to verify the user's email. The Confirm Your Email GUI 702 further comprises a Resend Email pushbutton 700. If the user does not receive the email from the system 100, the user can select the Resend Email pushbutton 700, and the system 100 will resend the verification email. The Confirm Your Email GUI 702 also comprises a Change Email Address pushbutton 701. The user may select the Change Email Address pushbutton 701 to change the email stored in the system 100. Once the user's email address has been verified, the user has access to the remaining functionality of the system 100.

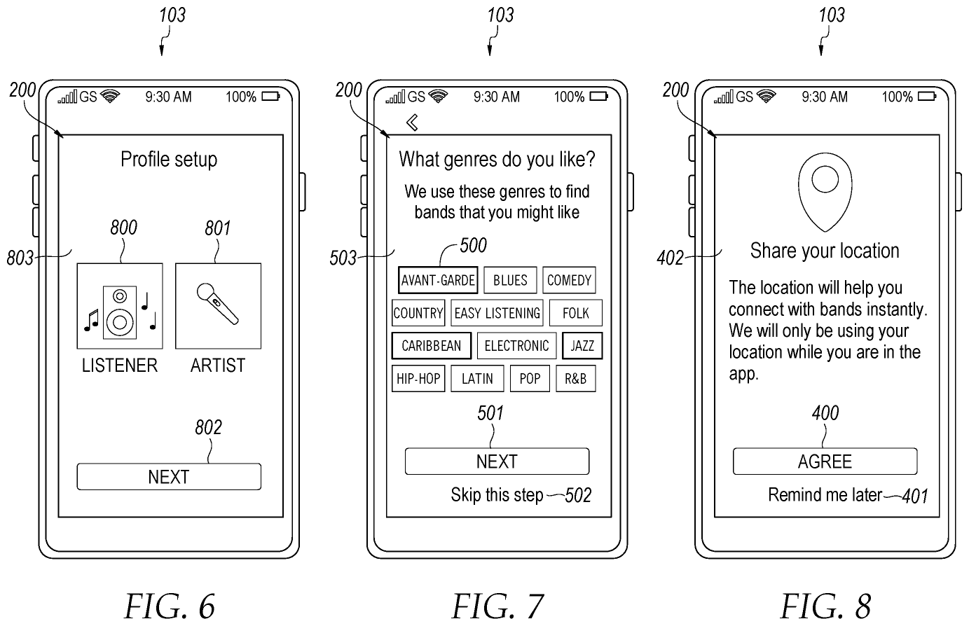

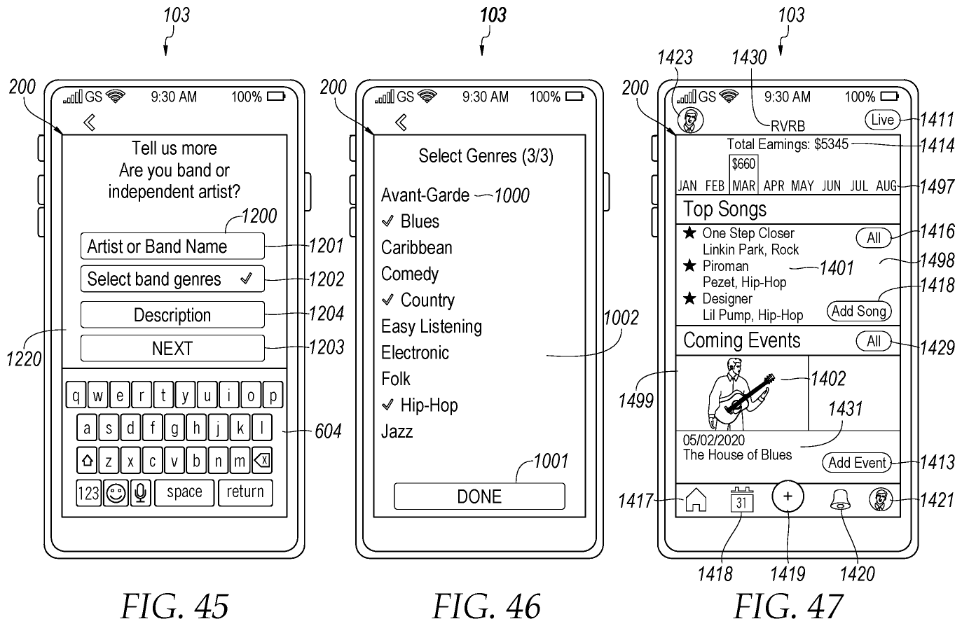

FIG. 6 depicts an exemplary Profile SetUp GUI 803 displayed to the display device 200 of the mobile device 103 by the music live application 216. In the Profile SetUp GUI 803, a user may select the Listener pushbutton 800 or select the Artist pushbutton 801. Thus, both listeners and artists can register with and use the system 100. Once the listener selects either Listener pushbutton 800, the listener selects the NEXT pushbutton 802, and the music live application 216 (FIG. 2) displays the Genre Selection GUI 503 depicted in FIG. 7. In this regard, the GUIs associated with a listener's experience with the system 100 differ from those GUIs associated with an artist's experience with the system 100. Discussion of the artists' GUIs begins at FIG. 45 herein. Those GUIs associated with the listener's experience are FIGS. 7-44.

FIG. 7 depicts an exemplary Genre Selection GUI 503 displayed to the display device 200 of the mobile device 103 by the music live application 216. The Genre Selection GUI 503 comprises a list 500 of different genres, including Avant-Garde, Blues, Comedy, Country, Easy Listening, Folk, Caribbean, Electronic, Jazz, Hip-Hop, Latin, Pop, and R&B. These are only exemplary genres and other genres may be used in other embodiments. When the listener selects a genre from the list, the music live application 216 highlights the listener's selections, and stores the listener's preference of genres. Once selections have been made, the listener selects the NEXT pushbutton 501, and the music live application 216 (FIG. 2) displays a Share Your Location GUI 402 depicted in FIG. 8. Note that the listener can skip the selection of genres by selecting the Skip this Step pushbutton 502 and continue straight to FIG. 8.

FIG. 8 depicts an exemplary Share Your Location GUI displayed to the display device 200 of the mobile device 103 by the music live application 216. If the listener desires to share their location with other listeners of the system 100, the listener selects an AGREE pushbutton 400. On the other hand, the listener can select the Remind Me Later pushbutton 401.

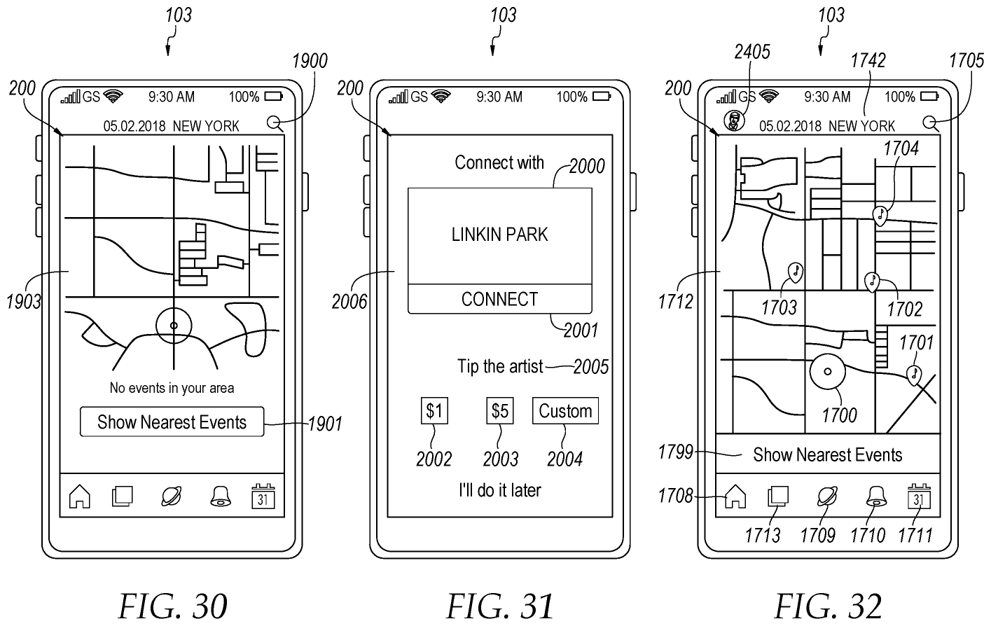

When the user selects the AGREE pushbutton 400, the music live application 216 may display to the display device 200 the Map GUI 1903 depicted in FIG. 30. FIG. 30 depicts a Map GUI 1903. The Map GUI 1903 has a Search button 1900. When the listener selects the Search button 1900, they can search the Artists, Events, or Users in the area. In the Map GUI 1903 shown in FIG. 30, no events were found listener's area. Further, the listener may select the Show Nearest Events pushbutton 1901, and if no events are found in the listener's area, the music live application 216 displays the text “No events in your area.”

FIG. 32 is an exemplary Home GUI 1712 displayed to the display device 200 of the mobile device 103 by the music live application 216 (FIG. 2) after the listener registers with the system 100. Notably, as the listener navigates through the GUIS 7-45, the listener can return to the Home GUI 1712 by selecting the Home icon 1708 at the bottom of the Home GUI 1712 or any other GUI in the system 100 that comprises the Home icon 1708. The Home GUI 1712 exhibits a wide range of functionality implemented on a map. In this regard, circle 1700 identifies the listener's current location obtained from the system's Global Positioning System (GPS) and a particular radius around the listener, and the teardrops 7001-7004 identify events and the location of those events where they are placed on the map. In one embodiment, the Home GUI 1712 could display teardrops 7001-7004 identifying events in the listener's favorite genre's as received as input in the Genre GUI 503 (FIG. 7).

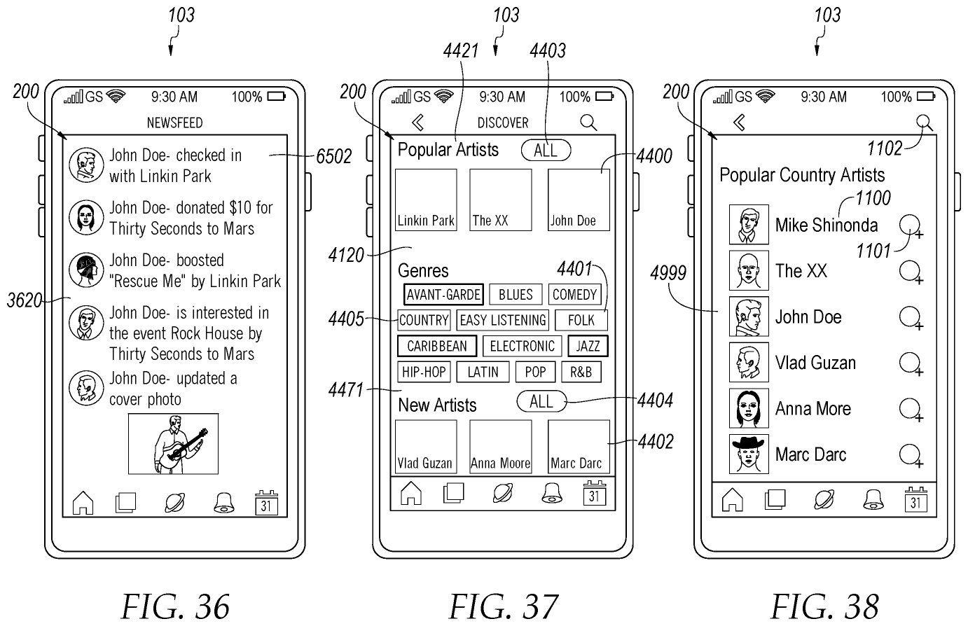

The Home GUI 1712 of FIG. 32 further comprises additional, selectable icons, including but not limited to a Newsfeed icon 1713 comprising squares transposed one over the other. When Newsfeed icon 1713 is selected by a user, FIG. 35 or 36 is displayed to the display device 200 of the mobile device 103 by the music live application 216. The Newsfeed GUI 6503 of FIG. 35 is displayed to the display device 200 of the mobile device 103 by the music live application 216 when there are no entries in the listener's newsfeed box 6502.

FIG. 36 is displayed to display device 200 of the mobile device 103 by the music live application 216 when entries to the newsfeed do exist. An exemplary Newsfeed GUI 3620 is displayed when there are entries in the listener's newsfeed. The contents of the newsfeed box 6502 contain updates related to users of the system 100. As mere examples, the newsfeed might indicate that a listener checked into a particular event, requested a song, or boosted a song. Once the listener has viewed their newsfeed, the listener can navigate back to the Home GUI 1712 of FIG. 32, or they can navigate to any other functionality via the other icons 1713, 1709, 1710, and 1711. For purposes of discussion, the listener navigates back to the Home GUI 1712 by selecting the icon 1708.

The Home GUI 1712 of FIG. 32 further comprises a Saturn icon 1709 that enables the discovery of artists, bands, and artists and bands in particular genres. When the Saturn icon 1709 is selected by the listener, the music live application 216 displays the Discover GUI 4420 of FIG. 37. The Discover GUI 4120 of FIG. 37 comprises three main sections including a Popular Artist section 4421 that contains a graphical representation of each artist or band listed as a Popular Artist. For example, the popular artist John Doe is graphically illustrated as a box 4400.

Further, the Discover GUI 4120 comprises a Genre section 4401 and a New Artist section 4471. If the listener selects one of the artists from the Popular Artist section 4421 or New Artist section 4471, the About GUI 7205 of FIG. 20 is displayed to the display device 200 of the mobile device 103 via the music live application 216. If the listener is not following the artist or band, they may select a Follow pushbutton 7201 so that the listener can follow the artist or band.

The About GUI 7205 further comprises a depiction of the artist or band in circle 7206, and a text box 7201 indicates whether the listener is following this band. In the exemplary About GUI 7205, the listener is following the artist or band as indicated by the word “FOLLOWING.” If the listener is not following the artist or band, the text box 7201 comprises the word “FOLLOW.” Further, the About GUI 7205 indicates the number of followers for the band (123), the number the band or artist is following (345), and the number of the events for the band (28). Further, the About GUI 7205 enables a listener to tip a band by selecting a $1-block 7202, a $5-block 7203, or a custom block 7204 where the listener can designate how much they would like to tip the band or artist.

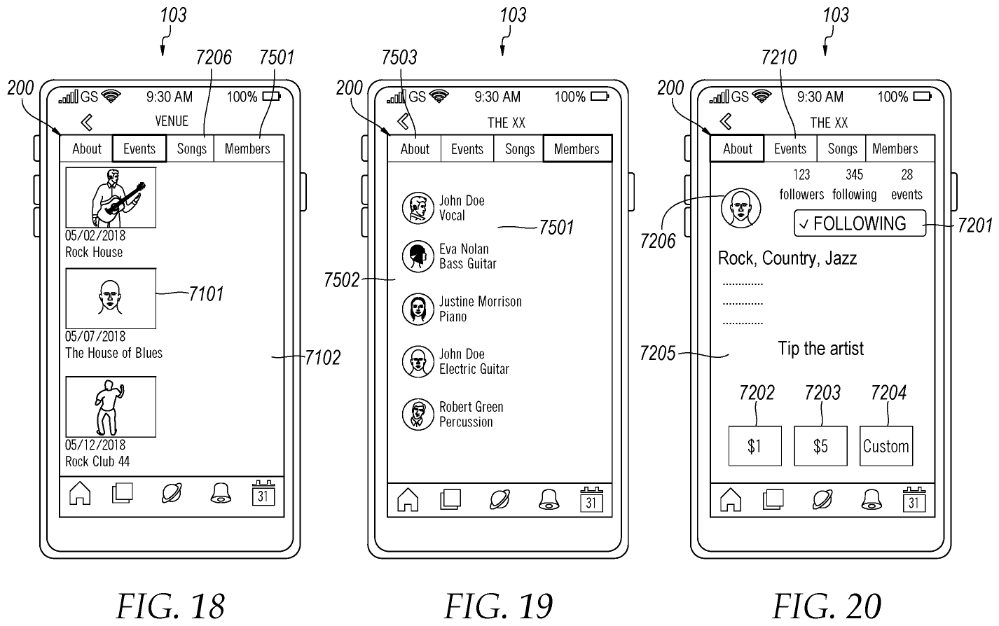

The listener may then see the list of events for the artist or band by selecting an Events button 7210, and the music live application 216 displays the Events GUI 7102 of FIG. 18. Events GUI 7102 comprises a listing of dates and venues where the identified Artists and Bands will be performing. Further, the listener may select the Songs button 7206. When the Songs button 7206 is selected, the music live application 216 displays to the display device 200 of the mobile device 103 the Songs GUI 2000 in FIG. 17 corresponding to the list of songs an artist or band has input.

From the Songs GUI 2000, the listener can navigate to the Members GUI 7502 in FIG. 19 by selecting the Members pushbutton 7208. The Members GUI 7502 lists the members of the band that was selected by the listener. The list 7501 is displayed by the music live application 216 of each of the band members, including the instrument played by the band member. The user can then select the About pushbutton 7503, and the music live application 216 displays to display device 200 of the mobile device 103 the About GUI 7205 shown in FIG. 20.

If the listener desires to connect to a live event, the listener selects one of the Event icons 1701-1704 on the Home GUI 1712 of FIG. 32. When an Event icon 1701-1704 is selected, music live application 216 displays the Connect GUI 2006 of FIG. 31. The Connect GUI 2006 of FIG. 31 comprises a Connect button 2001. When the listener selects the Connect button 2001, the listener is electronically and communicatively connected to the system of the band playing live, e.g., Linkin Park in box 2010. Under the section labeled Tip the Artist 2005, the listener can tip the artist or band money by selecting $1, box 2002, $5, box 2003, or Custom, box 2004.

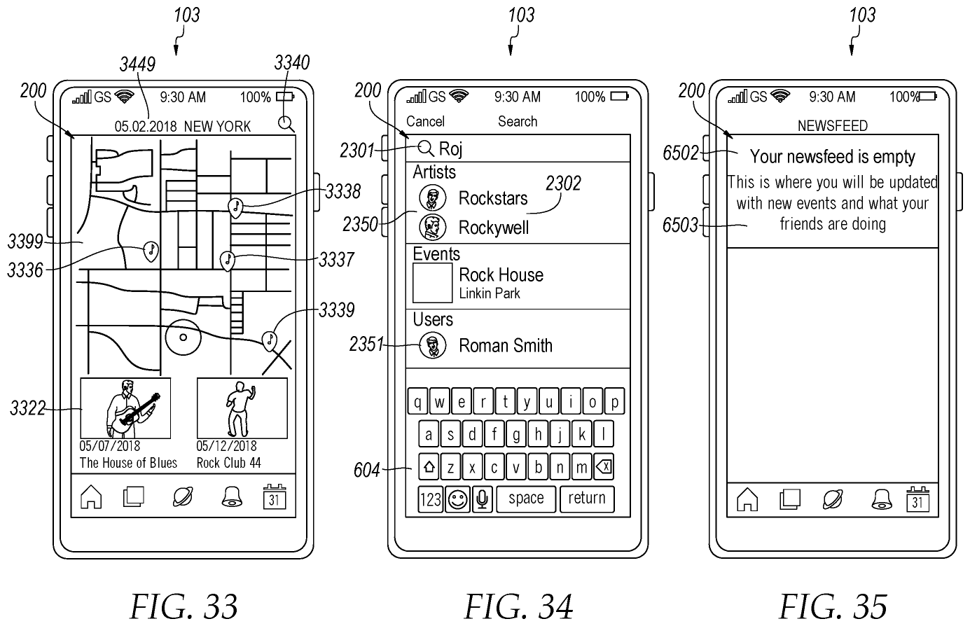

In one embodiment, if the listener selects the Linkin Park box 2010, the music live application 216 displays a Map GUI 3339 of FIG. 33. The Map GUI 3339 of FIG. 33 provides graphical representations 3322 of Artists or Bands to which the listener has connected. Further, the Map GUI 3339 shows other Events icons 3336-3339 showing where other events are occurring in the area indicated, i.e., New York on May 2, 2018. As described with respect to the system 100, the Map GUI 3339 comprises a Search icon 3340 that the user can use to search events occurring in the area indicated. Further, as is described, the date and location 3449 is selectable. Once selected, the music live application 216 displays a Location GUI 2299, which is described hereinabove with reference to FIG. 28.

With reference to FIG. 37, if the listener selects a genre from the Genre list 4401, the music live application 216 displays a list of artists or bands in the genre selected. For example, if the listener selects Country button 4405 the music live application 216 displays a list of country artists or bands as is shown in FIG. 38 in the Popular Country Artist GUI 4999. The Popular Country Artist GUI 44999 comprises an Artist/Band list 1100 of popular country artists and bands. The Popular Country Artist GUI 4999 further comprises a pushbutton 1101 to add information about the artist. Also, Popular Country Artist GUI 4999 comprises a search icon 1102 so listeners can search top country artists.

With reference to FIG. 37, what type of music selected by the listener from the Genre list 4401, e.g., Avant-Garde, Blues, Comedy, Country, Easy Listening, Folk, Caribbean, Electronic, Jazz, Hip-Hop, Latin, Pop, R&B, etc. determines the type of artists or bands that are listed in FIG. 38.

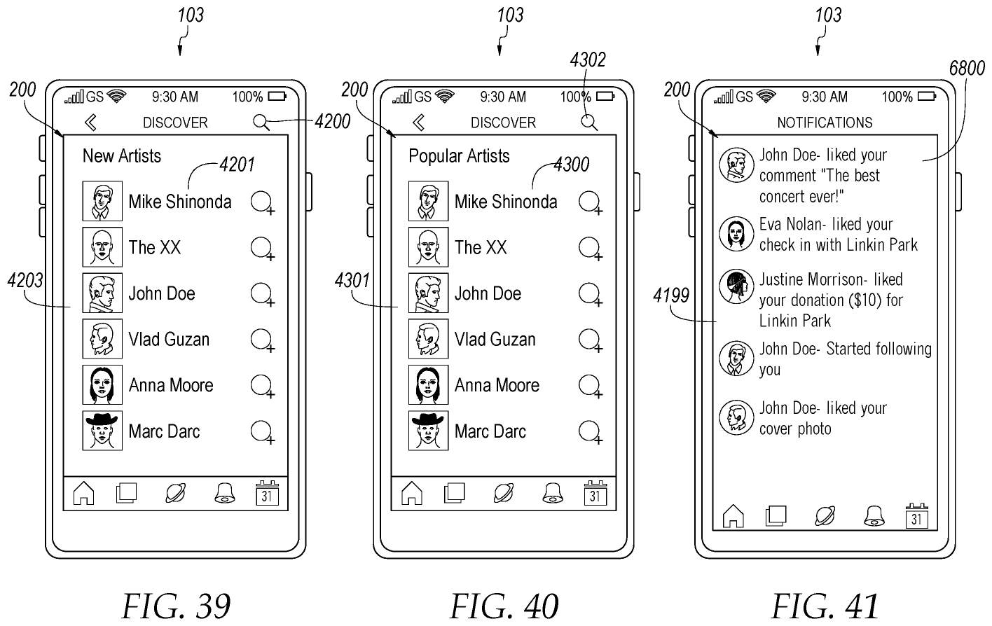

With reference to FIG. 37, the Discover GUI 4420 comprises two “All” pushbuttons, including All pushbutton 4403 and All pushbutton 4404. When a listener selects the All pushbuttons 4403 and 4404, the music live application 216 displays all the Popular Artists in FIG. 40 or all the New Artists in FIG. 39, respectively.

With respect to FIG. 40, when the display device 200 displays the Popular Artists GUI 4301 to the mobile device 103. The Popular Artists GUI 4301 comprises a list 4300 of popular artists. The listener may also select the search icon 4302 to search the Popular Artist list 4300 for a particular popular artist.

With respect to FIG. 39, the music live application 216 displays to the display device 200 of the mobile device 103 the New Artists GUI 4203 to the mobile device 103. The New Artists GUI 4203 comprises a New Artist list 4201 of new artists. The listener may also select the search icon 4200 to search the New Artist list 4201 for a particular new artist.

On the Home GUI 1712 of FIG. 32 is a Bell icon 1710. When the listener selects the Bell icon 1710, notifications related to the listener, or to Artists or Bands the listener follows, are listed in FIG. 41 in a Notifications GUI 4199. As noted in FIG. 41, the notifications may be related to a comment on a concert that another person attended, a “Like” when you check into a particular venue by another listener, a donation made to a band, or the like. This list is not intended to be limiting. Other comments or statements may be found in other embodiments.

The Home GUI 1712 of FIG. 32 further comprises a Calendar pushbutton 1711 that when selected displays the Events GUI 5904 shown in FIG. 43. FIG. 43 shows an Artist or Band list 5906 when the All Events pushbutton 5910 is selected. Thus, the Events GUI 5904 shows Artists or Bands coming to the listener's location, e.g., Linkin Park, Filip Band, Thirty Seconds to Mars, etc. Further, the Events GUI comprises an Interested In pushbutton 5911. When the listener selects the Interested In pushbutton 5911, the music live application 216 displays an Interested In GUI 5800 in FIG. 44. The Interested In GUI 5800 shows those events 5801 that the listener has indicated the listener is interested in attending. The listener can click on any of the events to see more information about the event.

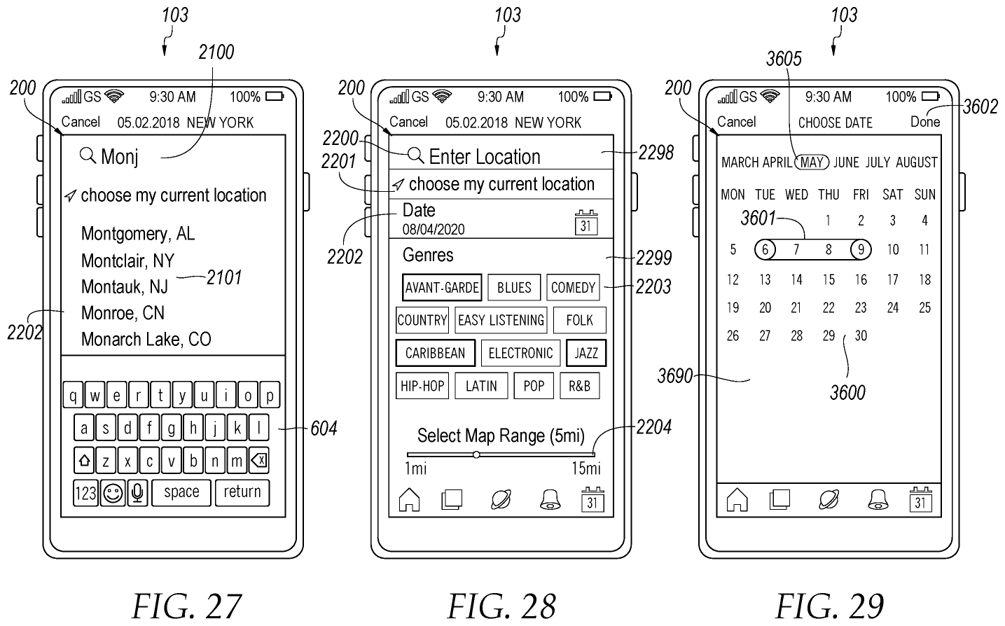

With reference to FIG. 32, in the Home GUI 1712, the date and city above the map are selectable. If the 05.02.2018 NEW YORK is selected by the listener, an Event Search Location GUI 2299 of FIG. 28 is displayed by the music live application 216. The Location GUI 2299 of FIG. 28 comprises a Search text box 2298. The listener can enter text in the Search text box 2298 for the city they desire to visit. In response, the music live application 216 displays a Search GUI 2201 as shown in FIG. 27. The Search GUI 2201 comprises a text box 2100 where the listener can begin typing their desired location via the keyboard 604, and as the listener types a location, a list 2101 appears matching what the listener is typing. The listener may then find the place where they would like to see a concert. Further, in Event Search Location 2299 the listener can select a date for Date text box 2202. When the listener selects the Date text box 2202, the Date GUI 3690 of FIG. 29 is displayed to the display device 200 by the music live application 216. The listener selects the date they desire to see an artist or band, and the music live application 216 navigates the listener back to the Enter Location GUI 2299. The listener can also select their desired genre from the list 2203. There is also a slide button 2204 that enables a listener to choose how far from the listener's current location to search for an event.

Once the listener has entered all the information in the Enter Location GUI 2299, the listener selects the Done pushbutton in the upper-righthand corner. Once the listener selects the Done pushbutton, the music live application 216 finds events that match the listener's criteria entered in the Enter Location GUI 2299. Once events are found, the music live application places identifiers, such as identifiers 1701-1704 on the map of the Home GUI 1712 of FIG. 32.

The Home GUI 1712 of FIG. 32 further comprises Show Nearby Events pushbutton 1799 that states “Click here to show nearest events.” When a listener is on the Home GUI 1712, the listener can select the Show Nearby Events pushbutton 1799, and the music live application 216 will place on the map identifiers that show where events are being held, which is described hereinabove. However, if no events are found in the listeners space the No Events GUI 1903 of FIG. 30 is displayed that states “Check Back Later for Events in Your Area.”

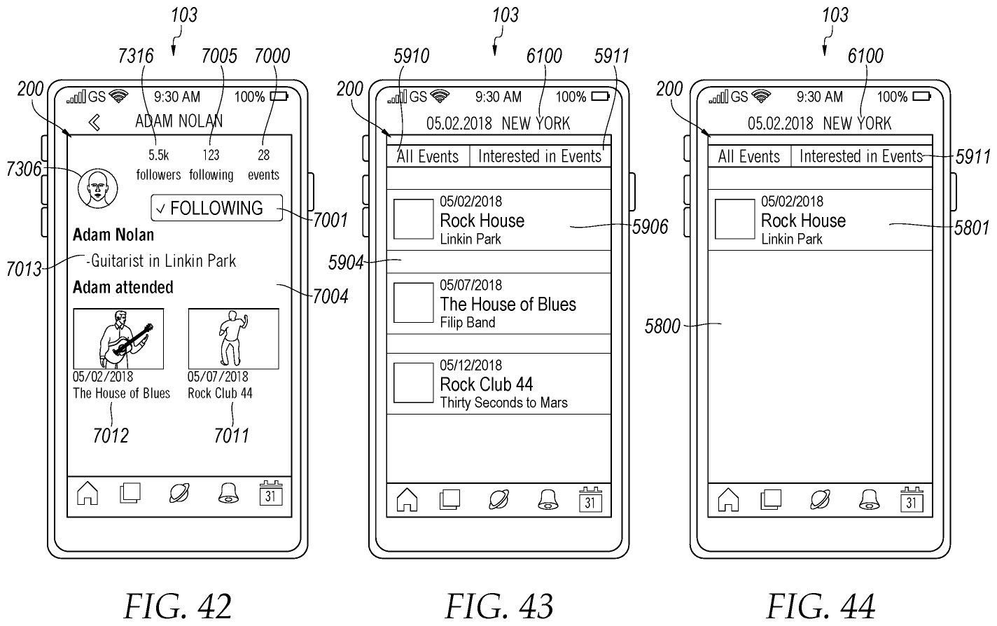

Additionally, FIG. 42 is an Artist or Band Profile GUI 7013. The Artist or Band Profile GUI 7013 comprises two events that the Artist has attended, including an event at the House of Blues and an event at the Rock Club 44. The Artist or Band Profile GUI 7013 comprises an entry 7013 that states that the Artist is a Guitarist for Linkin Park. A listener can select the Following pushbutton 7001 to stop following the Artist or Band or push the Follow pushbutton (not shown) that displays if the listener desires to start following the Artist or Band. Further, the Artist or Band Profile GUI 7013 shows followers (5.5 k), following (123), and events (28).

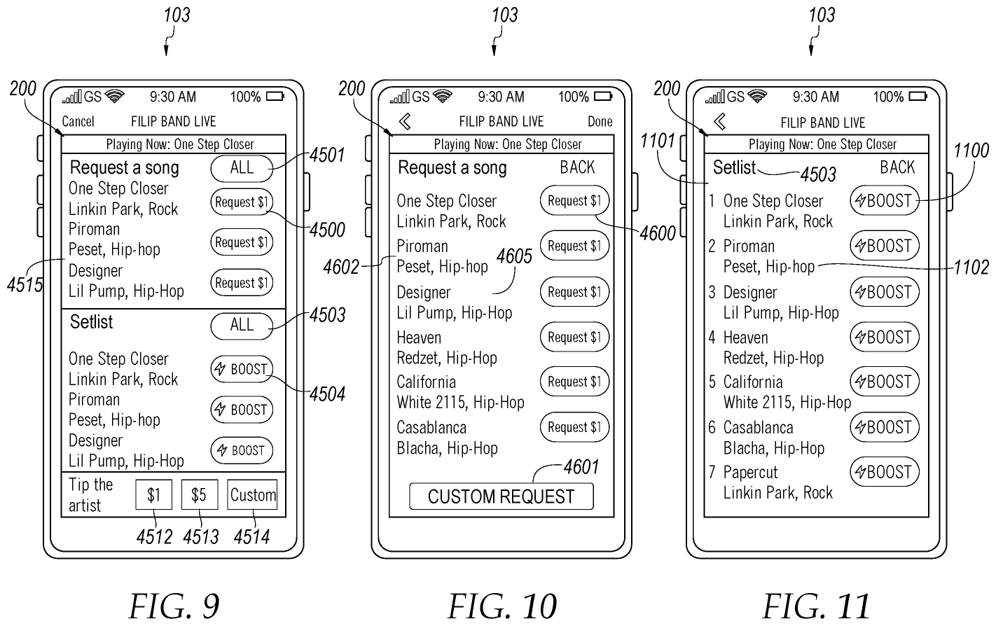

With the system 100, the listener can request songs, boost a song, or tip an artist or band. In this regard, the system 100 comprises a Request and Setlist GUI 4515 at FIG. 9, a Band Live Request a Song GUI 4602 at FIG. 10, and a Band Live Setlist GUI 1101 at FIG. 11. To navigate to a Request and Setlist GUI 4515, the listener selects one of the event icons 1701-1704 (FIG. 32) if the listener is connected to the artist or band through the Connect GUI 2006 of FIG. 31.

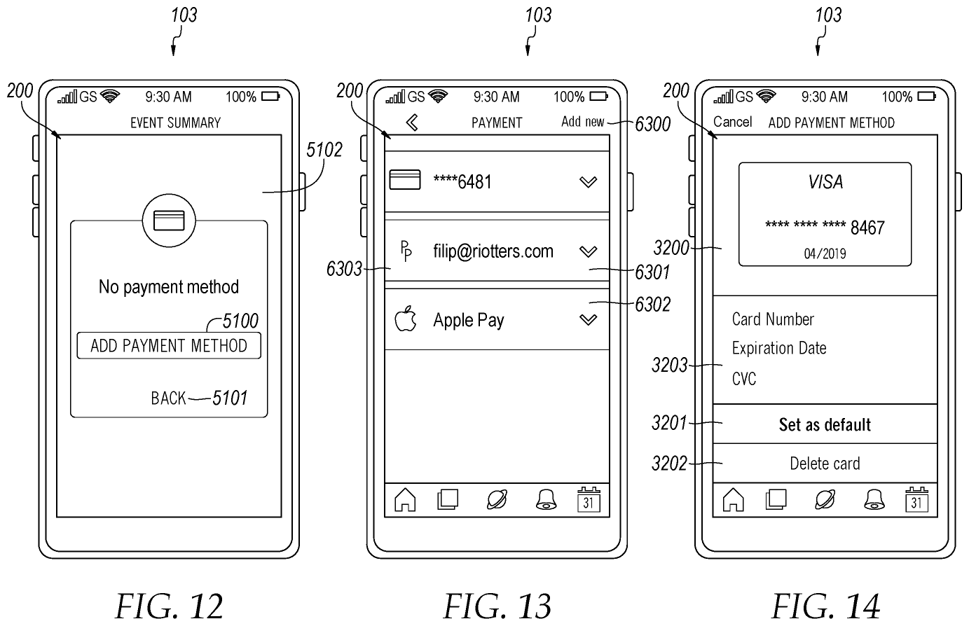

The Request and Setlist GUI 4515 allows a listener to request a song or boost a song all on a single Request and Setlist GUI 4515. In this regard, if a listener desires to request a song, the listener selects a Request $1 pushbutton 4500 aligned with the song the listener desires to hear. Upon selection, the music live application 216 displays the Event Summary GUI 5102 to the display device 200 of the mobile device 103. If the listener desires to enter a payment method, the listener selects the Add Payment Method pushbutton 5100 of FIG. 12. In response, the music live application 216 displays the Add Payment Method GUI 3200 of FIG. 14. The Add Payment Method GUI 3200 of FIG. 14 comprises a Number, Expiration and CVD number text box 3203 in which the listener can enter their debit or credit card information. The Add Payment Method GUI 3200 of FIG. 14 also comprises a Set as Default pushbutton that when selected will make the card entered the default payment method. Further, the Add Payment Method GUI 3200 of FIG. 14 also comprises a Delete Card pushbutton that when selected by the listener deletes the card from the system 100 as well as the payment server 106.

If the listener has already provided payment information, the music live application 216 displays the Payment GUI 6303 of FIG. 13. The Payment GUI 6303 shows three modes of paying. Credit Card Box 6300 indicates a debit or credit card stored on payment server that the listener can select to pay for a song request, a boost, or a tip. Email Box 6301 comprises an email that can be used via PayPal to pay for a song request, a boost, or a tip. Further, Apple Pay® box 6302 comprises an Apple Pay® button that can be used to pay for a song request, a boost, or a tip.

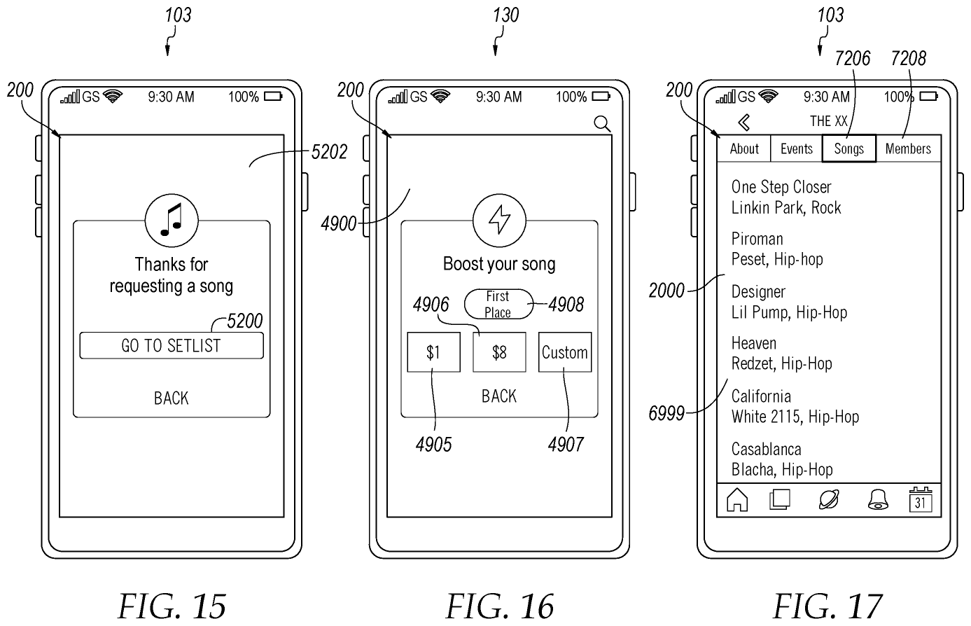

Once the listener has provided a valid payment method, the listener may select Request $1 pushbutton 4507 in FIG. 9 associated with a particular song, e.g., What Makes You Country. Once requested, the music live application 216 displays the Thanks for Requesting a Song GUI 5202 in FIG. 15. The listener can select the Go To Setlist pushbutton 5200, and the listener's song will appear on the Band Live Setlist GUI 1101 (FIG. 11) where the listener can boost the listener's song by selecting a Boost pushbutton 1100. That is, the listener can add an additional payment to have their song played before the other songs in the Setlist. If the listener does not desire to boost their song on the Setlist 1102, the listener can select the Back pushbutton 5101, which will return the listener to Request and Setlist GUI 4515 in FIG. 9.

As described, the requested song appears on the Band Live Setlist GUI 1101 (FIG. 11) among many other requested songs in the setlist 1102. Also described, if the listener desires their song to play ahead of those songs listed, the listener can select the Boost pushbutton 1100. When the listener selects the Boost pushbutton 1100, the music live application 216 displays a Boost Your Song GUI 4900 depicted in FIG. 16. The Boost Your Song GUI 4900 comprises a $1 Box 4905 that when selected the listener is charged a dollar and their song is boosted over another song in the Setlist. The Boost Your Song GUI 4900 comprises an $8 Box 4906 that when selected charges the listener eight dollars and boosts their song to the top of the setlist. The value of the $8 box is based on an algorithm that determines the difference between the price of the top song and the currently boosted song and is shown under the First Place oval 4908. Further, the Boost Your Song GUI 4900 comprises a Custom pushbutton 4907 that when selected, the listener may use their own dollar amount to boost their song. The music live application 216 displays the Band Live Setlist GUI 1101. The Band Live Setlist GUI 1101 comprises a plurality of songs that the artist or band has uploaded before the set. The listener's song that the listener requested or boosted now appears on the Setlist 1102.

With reference to FIG. 9, a listener can select the All pushbutton 4501, which navigates the listener to a list of all songs in the artist's or band's repertoire, which is the Request a Song List 4605. In this regard, the listener is navigated to Band Live Request a Song GUI 4602 in FIG. 10. From the Band Live Request a Song GUI 4602, the listener can request a song via a Request $1 pushbutton 4600, which navigates the listener to the Thanks for Requesting a Song GUI 5202 of FIG. 15. In the Thanks for Requesting a Song GUI 5202, the listener can elect to navigate to the Setlist 1102 FIG. 11. There the listener can decide whether to boost the listener's added song. With reference to FIG. 10, the listener can perform a custom request by selecting the Custom Request pushbutton 4601. Upon selection of Custom Request pushbutton 4601, the music live application 216 displays a GUI (not shown) that allows the listener to enter any amount of money the listener desires to request their song. The music live application 216 then performs an algorithm based upon the money provided for the various songs to determine the order of the Setlist 1102 (FIG. 11).

With reference to the Request and Setlist GUI 4515 FIG. 9, the listener can select a Boost pushbutton 4504. In response, the music live application 216 displays Boost Your Song GUI 4900 of FIG. 16 where the listener can select $1, $5, or a custom dollar amount to pay to boost the song associated with the Boost pushbutton 4504. Once the listener pays to Boost the chosen song, the music live application 216 performs an algorithm to determine where in the Setlist 1102 the song should be placed based upon the listener's payment and payment of other listeners.

With reference to the Request and Setlist GUI 4515 of FIG. 9, the listener can also select an All pushbutton 4503 related to the Setlist 1102 (FIG. 11). When selected, the music live application 216 displays Band Live Setlist GUI 1101 of FIG. 11, which shows all the songs in the Setlist 1102 and the order in which they will be played. In the Band Live Setlist GUI 1101, the listener can boost their song by selecting a Boost pushbutton 1100. In response, the music live application 216 displays the Boost Your Song GUI 4900 of FIG. 16 where the listener can pay $1, $5, or a custom amount of money to have their requested song played sooner than other songs. Based on the money provided to boost the song, the music live application 216 performs an algorithm on the pending songs, how much they were boosted, and how much the current song was boosted to determine the placement of songs in the Setlist 1102.

Referring again to FIG. 9, the Request and Setlist GUI 4515 further comprises pushbuttons for tipping the artist or band who is performing. In this regard, the Request a Song Request and Setlist GUI 4515 comprises a $1 pushbutton 4512 that tips the artist or band $1. The Request and Setlist GUI 4515 also comprises a $5 pushbutton 4513 that tips the artist or band $5, and the Request and Setlist GUI 4515 comprises a Custom pushbutton 4514 that tips the artist or band a dollar amount determined by the listener in a text box that is displayed to the listener by the music live application.

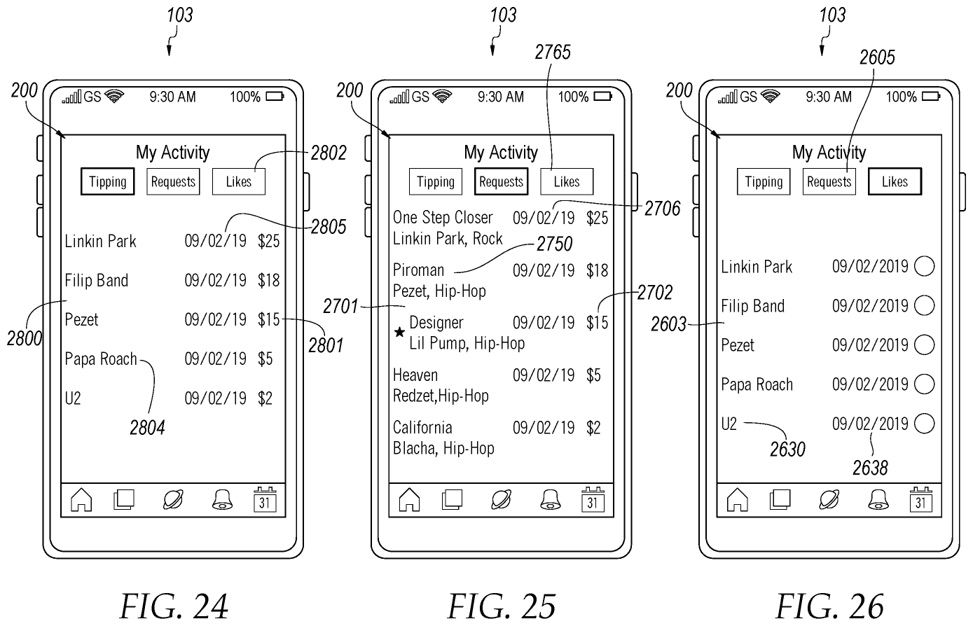

With reference to FIG. 32, the Home GUI 1712 comprises a Silhouette pushbutton 2405. When the listener selects the Silhouette pushbutton 2405, the music live application 216 displays a Profile GUI 2406 of FIG. 22. The Profile GUI 2406 comprises a Your Activity button 2401. When the Your Activity button 2401 is selected, the music live application 216 displays the My Activity Tipping GUI 2800 of FIG. 24. The My Activity Tipping GUI 2800 comprises a list of Bands 2804, e.g., Linkin Park, Filip Band, etc. Beside each Band is a column for Dates 2805 and Tip Amounts 2801 made on that date for the associated Band.

With reference to FIG. 24, the listener can select the Likes pushbutton 2802. When the Likes pushbutton 2802 is selected, the music live application 216 displays the Likes GUI 2603 of FIG. 26. The Likes GUI 2603 comprises a list of bands 2630 that the system 100 determines the listener likes based upon actions performed on the New sfeed GUI. Associated with each band is a date indicating when the band has played or will be playing soon.

With reference to FIG. 26, the listener can select the Requests pushbutton 2605. When selected, the music live application 216 displays a Requests GUI 2701 of FIG. 25. The Request GUI 2701 comprises a list of songs and their corresponding artists or bands 2750. The songs correspond to those artists and/or bands that the listener has tipped historically. Additionally, Request GUI 2701 comprises a Date 2706 associated with the tipping of the artist and/or band and an amount tipped 2702.

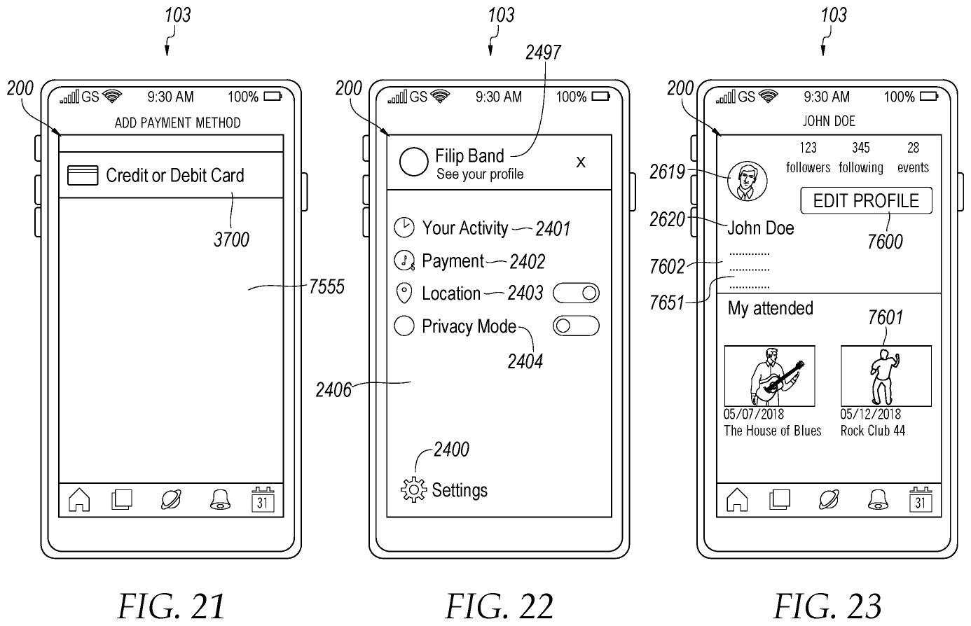

With respect to the Profile GUI 2406 of FIG. 22, the Profile GUI 2406 further comprises a Payment pushbutton 2402. When 2402 is selected, the music live application 216 displays Add Payment Method GUI 7555 of FIG. 21. The Add Payment Method GUI 7555 comprises a Credit Card or Debit Card pushbutton 3700. When the Credit Card or Debit Card pushbutton 3700 is selected by the listener, the music live application 216 displays the Add Payment Method GUI 3200 of FIG. 14. As described herein, the Add Payment Method GUI 3200 of FIG. 14 comprises a Credit Card Number, Expiration Date and CVC Number text box 4303 for entering the listener's credit or debit card information. Further, the Add Payment Method GUI 3200 of FIG. 14 comprises a Set as Default pushbutton 3201 and a Delete Card pushbutton 3202, as described above.

With reference to FIG. 22, the Profile GUI 2406 further comprises a Location slider 2403. In this regard, if the Location slide 2403 is on the right, then the music live application 216 has access to the listener's current location. However, if Location slide 2403 is to the left, the music live application 216 does not have access to the listener's present location.

Further with reference to FIG. 22, the Profile GUI 2406 comprises a Privacy slider 2404. In this regard, if the Privacy slide 2404 is on the right, then the music live application 216 will not update the Newsfeed GUI with any actions performed by the user. However, if it is the Privacy slide 2404 to the left, the music live application 216 does not have access to the listener's private information.

If the listener selects the Name icon 2497, the music live application 216 displays the Edit Profile GUI 7602 in FIG. 23. In the Edit Profile GUI 7602, a listener can edit their profile by selecting Edit Profile pushbutton 7600. The listener can change their photograph 2619, their description 7651 and username 2620, and events they have attended 7601.

With reference to FIG. 32, the Home GUI 1712 further comprises a Search icon 1705. When the listener selects the Search icon 1705, the music live application 216 displays the Search GUI 2350 of FIG. 34.

The Search GUI 2350 of FIG. 34 comprises a Search text box 2301 in which the listener can begin entering letters indicative of an artist, an event, or a listener for which the listener desires to locate in the system 100. If the listener searches for a particular artist 2302, the music live application 216 displays an About GUI like the About GUI 7205 of FIG. 20. In this regard, if the listener selects one of the artists from the Artist list 2302, the About GUI 7205 of FIG. 20 is displayed to the display device 200 of a mobile device 103 via the music live application 216.

In the About GUI of FIG. 20, if the listener is not following the artist or band, the listener may select a Follow pushbutton 7201. The listener may then see the list of events for the artist or listener by selecting the Event button 7210, and the music live application 216 (FIG. 2) displays the Events GUI 7102 of FIG. 18. Events GUI 7102 of FIG. 18 comprises an Artist or Band list 7101 and each is associated with a place and time, i.e., they are scheduled to play and include information on where the band or artist will be playing. Further, the listener may then select the Songs button 7206. When the Songs button 7206 is selected, the music live application 216 displays to the display device 200 of the mobile device 103 the Songs GUI 2000 in FIG. 17 corresponding to the artist or band selected.

In FIG. 34, the listener may also search for a particular event. For example, the listener may desire to search for the band Crush, so the listener enters the letters C-R-U-S-H, and the music live application 216 displays the band Crush under Artists and the band Crush under events, if they have scheduled an event. If the listener selects Crush from the Artist list an About GUI 7205 of FIG. 20 will display. If the listener selects Crush from the Event list 7101 (FIG. 18), the music live application 216 displays details about the event and an I'm Interested pushbutton. If the listener selects the I'm Interested pushbutton, then an entry for Crush in Interested Events GUI 5800 of FIG. 44 will show a Crush entry in the Interested Events (1) column 5911.

The listener can also select a listener 2351 in FIG. 34, e.g., Roman Smith, from the Search GUI 2350. When selected, the music live application 216 (FIG. 2) displays an About GUI 7004. The About GUI 7004 comprises numbers of followers 7316 (5.5 k), numbers following 7005 (123), and numbers of events 7000 (28). Additionally, the About GUI 7004 comprises a Follow pushbutton 7001, so if the listener desires to follow an Artist, Band, or a User, the listener can select the Follow pushbutton 7001. The About GUI 7004 also comprises the name of the listener and whether they are in a band and what instrument they play in entry 7013. Further, the About GUI 7004 shows events the listener has attended. For example, the listener in the About GUI 7004 has attended The House of Blues 7002 and the Rock Club 44 7003.

The following description relates to an Artist's or Band's use of the system 100 (FIG. 1). In this regard, FIGS. 45-67 depict exemplary GUIs used by the Artist or the Band to navigate the system. The first eight (8) GUIs are repeated here for clarity, but each corresponds to FIGS. 3-8 respectively.

FIG. 3 depicts an exemplary Welcome GUI 304 displayed to the display device 200 of the mobile device 103 by the music live application 216. The Welcome GUI 304 allows an Artist or Band who is already registered to sign into the system 100. The Welcome GUI 304 has a Label textbox 300 in which a user enters their label, also known as a username. Further, the Welcome GUI 304 has a Password textbox 301 in which a user enters their password. After the label and password are entered, the user selects the Select pushbutton 303, and the music live application 216 allows the user access to the system 100. Note that if the user desires, they can log on to the system 100 by selecting the Continue With Facebook hyperlink 302 and log on with their Facebook user identification and password.

FIG. 4 depicts an exemplary Sign Up GUI 605 displayed to the display device 200 of the mobile device 103 by the music live application 216. The SignUp GUI 605 allows a new user to provide credentials with which the user may use to access the system 100. The new user enters their label in a Label textbox 600 using keypad 604. The user enters a password in the Password text box 601 and enters the password again in the Confirm Password text box 602 using keypad 604. Once the information is entered, the user selects the NEXT pushbutton 603, and the music live application 216 displays the Confirm Your Email GUI 702 depicted in FIG. 5.

When the user navigates to the Confirm Your Email GUI 702 depicted in FIG. 5, the music live application 216 transmits an email to the user. To verify, the user selects a “Verify” button in the email. Then the user has access to the system 100. Through this transmitted email the user may respond by sending an email to verify the user's email. The Confirm Your Email GUI 702 further comprises a Resend Email pushbutton 700. If the user does not receive the email from the system 100, the user can select the Resend Email pushbutton 700, and the system 100 will resend the verification email. The Confirm Your Email GUI 702 also comprises a Change Email Address pushbutton 701. The user may select the Change Email Address pushbutton 701 to change the email stored in the system 100. Once the user's email address has been verified, the user has access to the remaining GUIs of the system 100.

FIG. 6 depicts an exemplary Profile SetUp GUI 803 displayed to the display device 200 of the mobile device 103 by the music live application 216. In the Profile SetUp GUI 803 a user may select the Listener pushbutton 800 or select the Artist pushbutton 801. Thus, both listeners and artists can register with and use the system 100.

Once the Artist or Band selects the Artist pushbutton 8001, the Artist or Band selects the NEXT pushbutton 802, and the music live application 216 displays the Tell Us More GUI 1220 depicted in FIG. 45. In this regard, the GUIs associated with a listener's experience with the system 100 differ from those GUIs associated with an artist's experience with the system 100. Discussion of the artists' GUIs begins at FIG. 45 herein. Those GUIs associated with the listener's experience are FIGS. 3-45.

In the Tell Us More GUI 1220 of FIG. 45, the Artist or Band can enter the Artist or Band name in the Artist or Band Name text box 1201. The Artist or Band can then enter a description of the Artist or Band in the Description text box 1204. The Artist or Band can then select the Genres pushbutton 1202.

Upon selection of the Genres pushbutton 1202, the music live application 216 displays to the display device 200 of the mobile device 103 a Select Genres GUI 1002 in FIG. 46. At this point in the setup of the Artist or Band account, the Artist or Band indicates in what Genre they perform. Thus, there is a list of many various genres, including, but not limited to Avant-Garde, Blues, Caribbean, Comedy, Country, Easy Listening, Electronic, Folk, Hip-Hop, and Jazz, only to name a few. The Artist or Band selects from the list their genre(s). In the Select Genres GUI 1002 shown in FIG. 46, the Artist or Band has selected Blues, Caribbean, and Hip-Hop as evidenced by the checkmarks beside these entries. When the Artist or Band selects the Done pushbutton 1001, the music live application 216 navigates the Artist or Band back to FIG. 45 where the selected genres are populated in the Select Band Genres text box 1202. The Artist or Band then selects a Next pushbutton 1203. Upon selection of the Next pushbutton 1203, the music live application 216 navigates the Artist or Band to the Dashboard GUI 1499 depicted in FIG. 47.

FIG. 47 provides an overview of activity by the Artist or Band and their listeners to some extent. The Dashboard GUI 1499 comprises three sections, including a Total Earnings section 1414, a Top Songs section 1498, and a Coming Events section 1402.

The Total Earnings section 1414 comprises a plurality of month indicators 1497. Each indicator 1497 represents a month of a year. The extent to which there is fill above the month indicator 1497 shows how much money the Artist or Band collected during the month indicated. So, for the example provided, the Artist or Band made $660, which is shown textually and graphically, in the month of March.

The Top Songs section 1498 comprises entries of songs. These songs represent the songs most requested at events by the Artist or the Band. This provides the Artist or the Band a sense of what their audience likes. Additionally, the Top Songs section 1498 comprises an All pushbutton 1416. When selected, the music live application 216 lists for the Artist or Band songs that are in the system 100 for the Artist or Band. In this regard, when the All pushbutton 1416 is selected the music live application 216 displays the My Songs Library GUI 6403 of FIG. 49. From the My Songs Library GUI 6403, the Artist or Band can search for songs using the Search text box 6401. Additionally, the Artist or Band can add a new song by selecting the Add New pushbutton 6402.

With reference to FIG. 47, in the Dashboard GUI 1499, the Top Songs section 1498 further comprises an Add Song pushbutton 1418, when no songs 1401 are listed. When an Artist or Band selects the Add Song pushbutton 1418, the music live application 216 displays the My Songs Library GUI 6400 of FIG. 49, and the Artist or Band can add a song in the Top Songs section 1498 of the Dashboard GUI 1499.

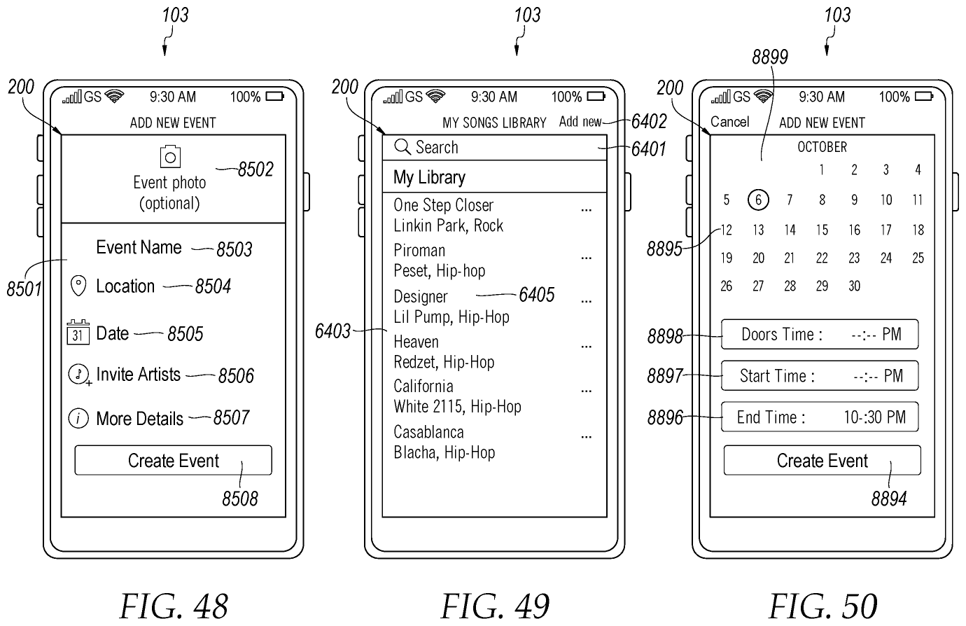

The Coming Events section 1402 provides a graphical representation of performances of the Artist or Band in the future. In the example provided, the Artist or Band will be performing on May 2, 2020, at The House of Blues. Further, the Coming Events section 1402 comprises an Add Event pushbutton 1413, when no songs 1401 are listed. When an Artist or Band selects the Add Event pushbutton 1413, the music live application 216 displays to the display device 100 of the mobile device 103 the Add New Event GUI 8501 depicted in FIG. 48.

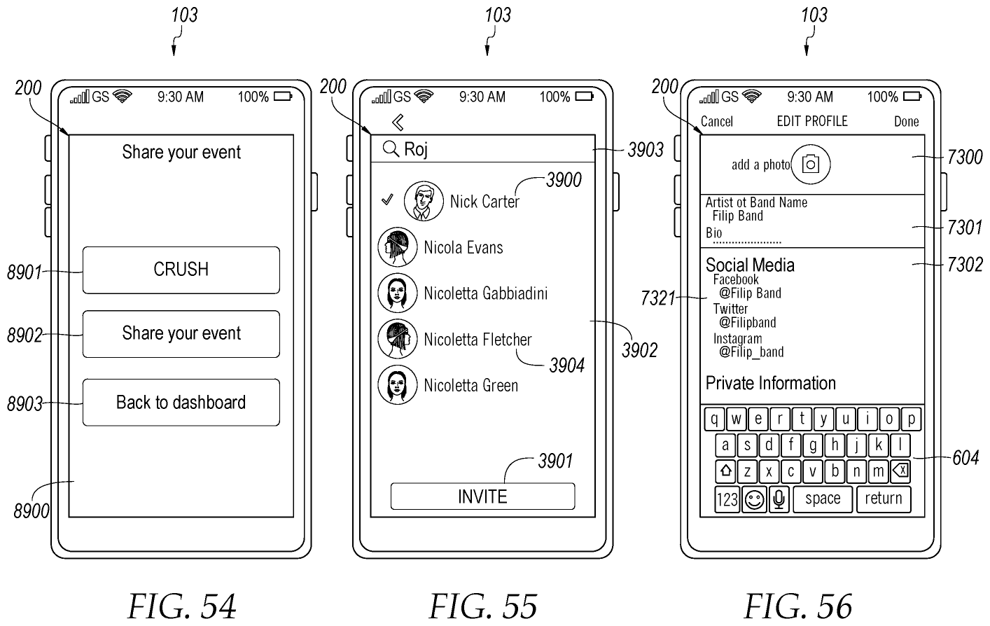

The Add New Event GUI 8501 depicted in FIG. 48 comprises an Event Name 8503, Location entry 8504, a Date entry 8505, and Invite Artists entry 8506, and a More Details entry 8507. Thus, the Artist or Band can enter the corresponding data into these fields. Additionally, the Artist or Band can upload a photograph in section 8502 for the Artist or Band event. Note that when entering a Location entry, the music live application 216 displays the Add New Event Search GUI 8102 shown in FIG. 53. The Add New Event Search GUI 8102 of FIG. 53 allows the Artist or Band to efficiently locate the location of the event by entering text in the Search text field 8601. When the Artist or Band selects to enter the date of the event, the music live application 216 displays to the display device 200 of the mobile device the Add New Event GUI 8899 depicted in FIG. 50. The Add New Event GUI 8899 of FIG. 45 comprises a calendar 8895 with which the Artist or Band can select a date. Additionally, the Add New Event GUI 8899 of FIG. 45 comprises a text box for entering door time, start time, and end time for the event being added. The Artist or Band then selects the Create Your Event pushbutton 8894, and the music alive application 216 displays the Share Your Event GUI 8900 depicted in FIG. 54. The Share Your Event GUI 8900 of FIG. 54 comprises the name of the Band playing at the event in block 8901. The Artist or Band can then select the Share Your Event pushbutton 8903, and a GUI (now shown) will come up that enables the Artist or the Band to text, email, or otherwise share news of the up and coming event. Once the Artist or Band has completed the Share your Event GUI 8900, the Artist or Band selects the Back to Dashboard pushbutton 8903, and the music live application 216 navigates the Artist or Band back to the Dashboard GUI 1499 in FIG. 47. The coming event entered by the Artist or Band appears in the Coming Events section 1402 of FIG. 47.

Further, FIG. 47 comprises a Band Selection link 1430. The Band Selectin link 1430 recites the Band RVRB as the selected Band for the Dashboard GUI 1499. However, the individual using the system 100 may be a member of more than one band or may be an individual Artist. Thus, the Artist or Band can have a plurality of Artists or Bands associated with its system 100. In this regard, when the Band Selection link 1430 is selected, the music live application 216 displays a GUI (not shown) in which the Band or Artist may select a Band or Artist different than RVRB. In one embodiment, the music live application 216 may display a list of Artists or Bands associated with the user of the system 100. The Band or Artist selects a different Band or Artist, and the music live application 216 returns to the Dashboard GUI 1499 of FIG. 47 and displays the information associated with the new Artist or Band selected.

With reference to FIG. 48, if the Artist or Band desires to invite particular people to an event, the Artist and/or Band can select the Invite Artists pushbutton 3901. When selected, the music live application 216 displays the Search Invitees GUI 3902 of FIG. 55 to the display device 200 of the mobile device 103. The Search Invitees GUI 3902 of FIG. 55 comprises a Search text box 3903 in which an Artist or a Band can begin entering an invitee name, and the music live application 216 will display a list 3904 of names like the text entered by the Artist and the Band. Once an invitee is located, the Artist or Band selects the Invite pushbutton 3901, and the person is invited electronically, e.g., email or text, to the event. The Artist and Band can then navigate back to the Dashboard GUI 1499 of (FIG. 47).

With respect to navigation, the Dashboard GUI 1499 of FIG. 47 comprises a Home icon 1417. If throughout the system 100, the Artist or Band desires to navigate back to the Dashboard GUI 1499, they select the Home icon 1417.

The Dashboard GUI 1499 of FIG. 47 comprises an Addition pushbutton 1419. When selected, the music live application 216 displays a pushbutton for the Artist or Band to Create a New Event, Add a Song or Cancel. If the Artist or Band Selects the Create a New Event pushbutton (not shown), the music live application 216 displays to the display device 200 of the mobile device 103 an Add New Event GUI 8501 in FIG. 48, which is described hereinabove.

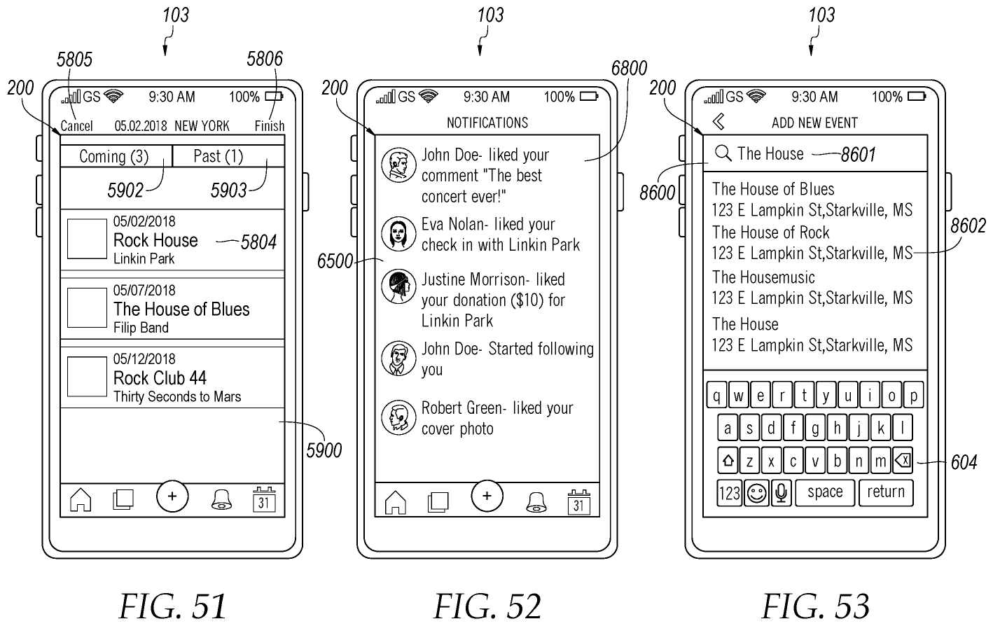

Additionally, the Dashboard GUI 1499 of FIG. 47 comprises a Calendar icon 1418. When selected, the music live application 216 navigates the user to the Coming GUI 5900 depicted in FIG. 51. FIG. 51 shows when the Coming pushbutton 5902 is selected and listing all the events coming to an area. The Artist or Band may also select the Past pushbutton 5903 to list all past events. In one embodiment, the Coming GUI 5900 could also have an Invited pushbutton (not shown) that when selected shows all the individuals that have been invited to a particular event.

The Dashboard GUI 1499 of FIG. 47 further comprises a Bell icon 1420. When the Bell icon 1420 is selected, the music live application 216 displays the Notifications GUI 6500 of FIG. 52. The Notifications GUI 6500 comprises a list of events or happenings related to the system 100.

When an Artist or Band selects the Headshot icon 1421, the music live application 216 displays a Profile GUI 7602 FIG. 23 like the listener's Profile GUI. The Edit Profile GUI 7321 of FIG. 23 of an Artist or Band would have an Edit Profile pushbutton 7600. Upon selection of the Edit Profile pushbutton 7201, the music live application 216 displays an Edit Profile GUI 7321 of FIG. 56 that comprises text boxes 7202 for Artists and Bands to enter and/or change their Artist name or Band name and/or add a biography. Further, the Edit Profile GUI 7321 may enable the Artists or Bands areas 73002 for entering Facebook links®, Twitter links®, and Instagram® links related to the Artist or Band.

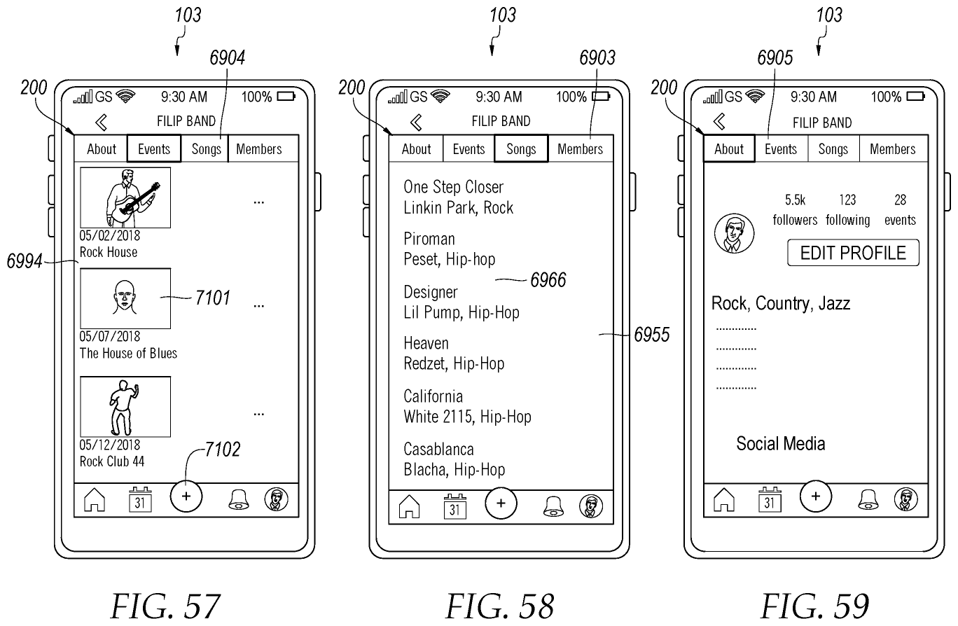

In the Songs GUI 6955 of FIG. 58, the Artist or Band selects the Events pushbutton 6905. In response, the music live application 216 displays to the display device 200 of the mobile phone 103 the Events GUI 6994 of FIG. 57. The Events GUI 6994 of FIG. 57 displays a list of events 7101 the band entered, which is described herein. Further, from the Events GUI 6994 of FIG. 57, an Artist or Band can add an event or a song via the “+” icon 7102.

From the Events GUI 6994, the Artist or Band can select the Songs pushbutton 6904. In response, the music live application 216 displays to the display device 200 of the mobile device 103 displays the Songs GUI 6995 of FIG. 58. The Songs GUI 6955 of FIG. 58 displays a list 6966 of songs the Artist or Band has entered in their library, as described above. If a Band is using the system 100, they can add members of their band to the system 100. In this regard, from the Songs GUI 6955 of FIG. 58, the Band can select the Members pushbutton 6903.

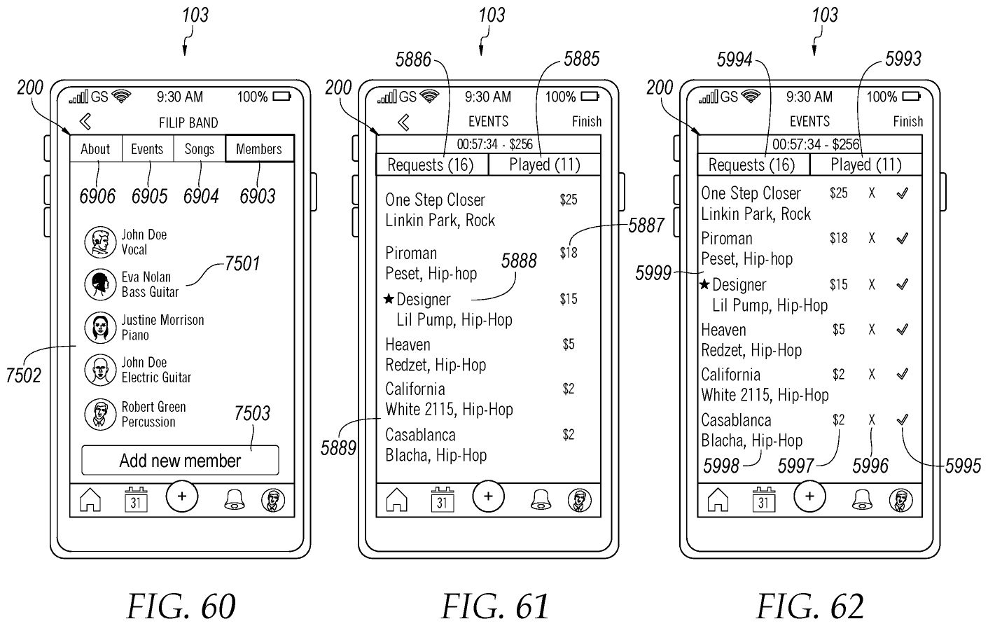

In response, the music live application 216 displays to the display device 200 of the mobile phone 103 the Members GUI 7502 of FIG. 60. The Members GUI 7502 displays a list 7501 of members of the band indicated, The XX, and the instrument each member plays in the Band. The Members GUI 7502 of FIG. 60 further comprises an Add New Member pushbutton 7503. When selected, the music live application 216 displays a window having a plurality of text boxes for entering identifying information of a new member.

With reference back to FIG. 47, the Dashboard GUI 1499 comprises a Coming Events section 1402. The Coming Events section 1402 is interactive. In this regard, an Artist or Band can select the 05/02/2020 The House of Blues box 1431. If the event is active, i.e., ongoing, the music live application 216 displays to the display device of the mobile device 103 the Events GUI 5889 of FIG. 60.

The Events GUI 5889 of FIG. 61 comprises a list of songs 5888 that have been requested by listener(s) using FIGS. 3-45. The songs are listed in order of money amounts 5887 ranging from the most money dedicated to the first song to the least money dedicate to the last song. In this regard, a listener(s) paid $25 to hear One Step Closer by Linkin Park but only $2 to hear Casablanca by Blacha. At any time while on the Events GUI 5889, the Artist or Band can select the Requests pushbutton 5886 and the Played pushbutton 5885 to see what songs have been requested and what songs have been played, respectively.

If the event is not active, i.e., has not been started, the music live application 216 displays information regarding the event. For example, the music live application 216 might display the name of the band, the location of the event, the date and times of the event, and there may be a section for interested listeners to select to get on an interested listeners list.

FIG. 62 depicts a Requests GUI 5999. The Requests GUI 5999 comprises a Requests pushbutton 5994 and corresponding list 5998 that shows all the songs listener(s) have requested the Artist or Band to play. List 5997 shows the monetary value(s) of all the songs for which requests have been made. Requests GUI 5999 also displays X's 5996 which allow the band or artist to decline a song request and the checkmarks 5995 which allow a band or artist to accept a song request. Additionally, the Requests GUI 5999 comprises a Played pushbutton 5993 of all the songs that have been accepted by the band or artist.

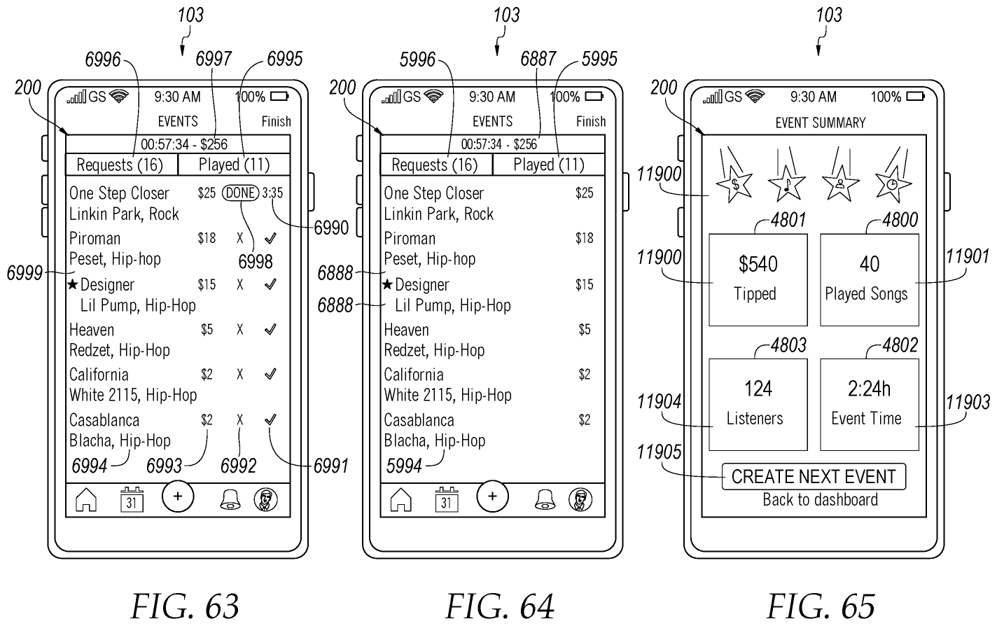

FIG. 63 depicts a Requests GUI 6999 that is like Requests GUI 5999 in FIG. 61. In this regard, Requests pushbutton 6996 shows the songs 6994 requested by listener(s), and the Played pushbutton 6995 shows the songs that have not yet been played 6991 or begun 6992. Once the checkmark 5995 is selected, the music live application 216 displays a Done oval 5998 and a timer indicating the amount of time the song has been playing 6990.

FIG. 64 depicts a Requests GUI 6888 that is like Requests GUI 5999 in FIG. 62. In this regard, Requests pushbutton 5996 shows the songs 5994 requested by listener(s), and the Played pushbutton 5995 shows the songs that have been played. Once the set is over for the Artist or Band, they can see a total amount of money made 6887 during a performance. Further, the Artist and/or Band can see which songs received the greatest amount of remuneration.

Once an event is finished, the music live application 216 displays the Event Summary GUI 11900 shown in FIG. 65. The Event Summary GUI 11900 comprises a Tip block 11902 that shows how many tips were received during a performance. Further, the Event Summary GUI 11900 comprises a Played Songs block 11901 that indicates how many songs were played during the performance. Finally, the Event Summary GUI 11900 comprises a Listeners block 11904 that shows how many listeners the performance had and the Event Time block 11905 that shows how long the performance lasted.

From Event Summary GUI 11900 shown in FIG. 65, the Artist or the Band can select a Create Next Event pushbutton 11905. When selected, the music live application 216 displays to the display device 200 of the mobile device 103 an Add New Event GUI 8501 of FIG. 48 so that the Artist or the Band can schedule a new event.

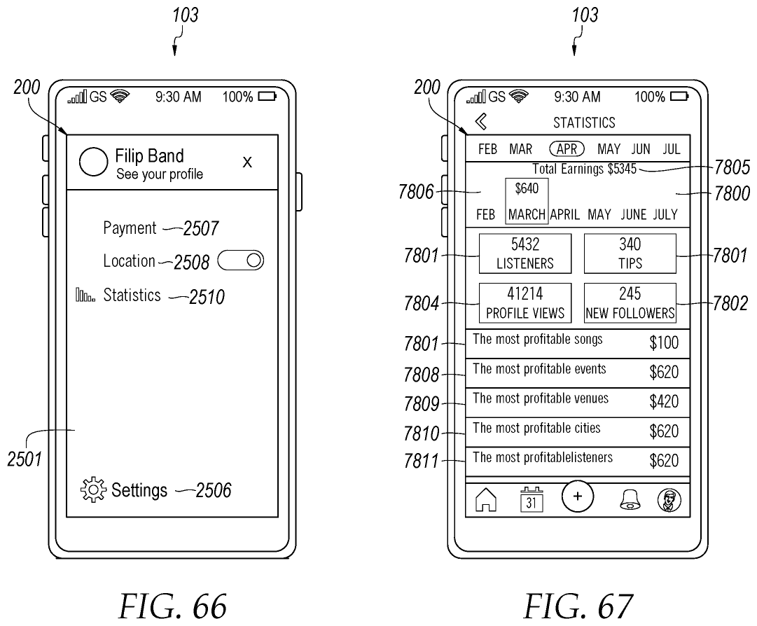

With reference to FIG. 47, the Dashboard GUI 1499 comprises a Silhouette pushbutton 1423 at the top left-hand corner of the Dashboard GUI 1499. When an Artist or Band selects the Silhouette GUI 1423, the music live application 216 displays an Artist's or a Band's profile as shown in Profile GUI 2501 of FIG. 66. The Artist or Band can select on the Payment link 2507, and the music live application 216 displays the Artist's or Band's bank account information and/or debit/credit card information. Note that during an event, the Artist or Band accumulates an amount of money from listeners via song requests payments and tipping payments. During the event or after the event has ended, the payment server 106 credits the bank account or other financial account, e.g., a debit or credit card, of the Artist or Band that received the song request payments and the tipping payments.

The Artist or Bank may select a Location slide button 2508 to turn on/off location services through the system 100. Further, the Artist or Band can select Statistics 2510. In response, the music live application displays the Statistics GUI 7806 of FIG. 65.

The Statistics GUI 7806 of FIG. 67 comprises an overview of the statistics kept by the system 100 during performances by Artists and Bans. The Statistics GUI 7806 of FIG. 66. In block 7800 is a rectangular indicator that indicates how much money the Artist or Band made in the month of March. Text 7805 displays the total amount of money the Artist or Band has made during use of the system 100. Listeners block 7801 indicates that 5432 listeners have listened to their music and participated through the system 100, Tips block 7801 provides the total tip amount of $340 received by the Artist or Band, Profile Views block 7804 indicates that 41,214 listeners have viewed the Artist's or Band's profile, and New Followers block indicates that the Artist or Band has picked up 245 new followers.

In generating the statistics, the music live application 216 keeps records of various statistics. These are listed in Statistics GUI 7806 of FIG. 67. In this regard, block 7801 indicates the most profitable songs at $100, block 7802 indicates the most profitable events at $620, and block 7809 indicates the most profitable venues at $420. Additionally, the Statistics GUI 7806 of FIG. 67 comprises a block 7810 that indicates the most profitable cities and block 7811 that indicates the most profitable listeners.

What I claim is:

1. A method for digitally interacting with an artist or band that is playing a live show, the method comprising:
automatically receiving, over a communications network from an operations computing device comprising a first microprocessor from a listener mobile device operated by a first listener, a first electronic request, the listener mobile device comprising a second microprocessor, the first electronic request comprising data indicative of a least one live performance and data indicative of a requested song the first listener desires to be performed at a first live performance by an artist or a band and an amount of money to be paid by the first listener for the requested song;
automatically displaying, by the second microprocessor, a payment graphical user interface requesting mode of payment information;
automatically receiving, by the first microprocessor, data indicative of a mode of payment;
automatically processing, by the first microprocessor, the amount of money in the first electronic request through the mode of payment;
after confirmation of receipt of payment through mode of payment, automatically transmitting, by the first microprocessor, information about the requested song and the amount of money in the first electronic request to the first listener mobile device;
automatically transmitting, by the first microprocessor, information about the requested song and the amount of money in the first electronic request to one or more other listener mobile devices operated by a plurality of one or more other listeners, respectively;
automatically determining, by the first microprocessor, a placement of the requested song in the first electronic request in a list of requested songs, the list of requested songs comprising a plurality of requested songs from the plurality of other listeners, wherein the placement of the requested song is based on the amount of money in the first electronic request as compared to an amount of money received associated with each song in the plurality of requested songs;
automatically updating, by the first microprocessor, the list of the requested songs based upon the automatic determination of placement;
automatically transmitting, by the first microprocessor, data indicative of the list of requested songs to an artist or band mobile device via the communications network, the artist or band mobile device further comprising a third microprocessor;
automatically receiving, by the third microprocessor of the artist or band mobile device, the data indicative of the list of requested songs; and
automatically displaying, by the third microprocessor of the artist or band mobile device, the data indicative of the list of requested songs to the artist or band mobile device for selection by a user of the artist or band mobile device which of the requested songs to be played by the artist or band.
